(19) United States
(12) Patent Application Publication
(10) Pub. No.: US 2018/0112389 A1
(43) Pub. Date: Apr. 26, 2018

(54) Composite concrete and foam building component

(71) Applicants: Adam G. Lake, Enoch, UT (US); Genevieve Lake, Enoch, UT (US); Lawrence B. Lockwood, San Diego, CA (US); Mark P. Hunton, Enoch, UT (US)

(72) Inventors: Adam G. Lake, Enoch, UT (US); Genevieve Lake, Enoch, UT (US); Lawrence B. Lockwood, San Diego, CA (US); Mark P. Hunton, Enoch, UT (US)

(21) Appl. No.: 15/566,079

(22) PCT Filed: Apr. 14, 2016
(86) PCT No.: PCT/US2016/027635

§ 371 Date: Oct. 12, 2017

Related U.S. Application Data
(60) Provisional application No. 62/147,506, filed on Apr. 14, 2015.

(51) Int. Cl. E04B 1/16; E04B 7/02; E04B 1/41; E04B 2/86; C04B 16/08; C08G 63/08

(52) U.S. Cl. CPC E04B 1/167; E04B 7/02; E04B 1/4114; C08G 2101/0025; C04B 16/08; C08G 63/08; E04B 2/86

(57) ABSTRACT

A composite foam and concrete building component (1) for forming panels such as walls and roofs includes a central core (4) of structural concrete as a framework of spaced posts (6) and beam (7) structures, around blocks (8) of rigid, closed cell foam material such as expandable polystyrene (EPS) foam or expanded poly-lactid acid (PLA) foam. The core is straddled by front and back layers (2,3) of low density, cellular concrete, thus encapsulating the foam blocks. Cellular concrete plugs (14) can extend through the foam blocks to bond the layers together. The component can be formed by separately pouring the structural and cellular concrete without significantly altering the formwork.

### PRIOR APPLICATION

The invention claims the benefit of U.S. Provisional Patent Application Ser. No. 62/147,506 filed 2015 Apr. 14 incorporated herein by reference.

### FIELD OF THE INVENTION

The invention relates to the construction industry, and more particularly, to dwelling structures such as single family detached buildings constructed using concrete.

### BACKGROUND

Conventional techniques for building structures such as homes and offices are resource and time-intensive, and yet can yield an inferior product. For instance, most new homes are constructed as “stick-built homes,” i.e., built mainly with lumber boards as the skeletal superstructure of the walls and roof, and later filled in with fiberglass insulation and typically covered with drywall, plaster or stucco.

Stick-built homes often require a large team of different tradespersons—from framers, insulation installers, drywall hangers, stucco appliers, to plaster appliers. This labor can be very expensive. Further, the construction of such homes use resource-depleted materials such as such as chemically treated lumber which can emit dangerous chemicals, or foster the growth of mold or other pathogens. Such homes can suffer from insect infestations such as termites, are susceptible to fire damage, and often require dedicated routine maintenance. Such homes are also susceptible to being severely damaged by weather extremes such as tornadoes, hurricanes, and floods. Thus, the life expectancy of typical stick-built homes is often relatively short.

In addition, traditional stick-built homes are often relatively energy inefficient. With the costs of energy increasing and with a growing awareness of environmental concerns, energy efficiency is becoming a critical consideration in home design and construction.

Although the vast majority of new homes are constructed of wood, attempts have been made to construct homes from concrete and other materials. While addressing some of the problems of fire and termite susceptibility, and improving insulation, this building technology is currently more expensive than traditional wood structures, and has thus failed to gain any significant market penetration.

Structural concrete has physical properties which lend itself the ability to form many structural building components such a beams, columns, walls, floors, and roofs. Structural concrete is often reinforced with reinforcing bars such as rebar to improve its tensile strength. Structural concrete is relatively dense at about 2400 kilograms per cubic meter and thus may not be suitable for many applications requiring lower weight or better thermal insulation. Cellular concrete, also know as aerated concrete, contains diffused tiny air pockets resulting in densities between about 400 and 1600 kilograms per cubic meter and thermal conductivities of between about 0.1 and 0.6 watts per meter degree kelvin.

Expanded polystyrene (EPS) is a rigid, closed-cell foam that can be formed into light-weight sheets of material that have been used for building insulation. Its density can vary greatly depending on how much the foam has been expanded. For most building insulation applications its thermal conductivity can range between about 0.032 and 0.038 watts per meter degree kelvin depending on the density. Densities Compressive strength should be no less than 0.1 Mpa (15 pounds per square inch)

Therefore there is a need for a home building system which addresses some or all of the above identified inadequacies.

### SUMMARY

The principal and secondary objects of the invention are to provide an improved structural planar component for building dwelling structures. These and other objects are achieved by a composite concrete building component including structural concrete, cellular concrete, and integrated insulating rigid foam.

In some embodiments there is provided a composite concrete building component constructed by setting a first set of form panels to provide a supportive structure for a first side of a composite concrete building component, installing internal foam blocks comprising spaces between individual ones of the internal foam blocks to create substantially vertical voids extending along a substantial portion of the width of the composite concrete building component.

In some embodiments a second set of form panels is provided to support the second side of a composite concrete building component and reinforced structural concrete is poured into the voids to create concrete posts and on top of the internal foam blocks to create one or more substantially horizontal beams.

In some embodiments the first and second sets of form panels are repositioned away from the internal foam blocks and reinforced concrete posts to form voids into which cellular concrete is poured.

In some embodiments there is provided a composite building component comprises: a pair of stratiform layers of cellular concrete straddling a core; wherein said core comprises a framework of structural concrete interspersed with a number of rigid, closed-cell foam blocks.

In some embodiments said component further comprises: a footing; said framework comprises: a beam elongated along a width dimension; an adjacent pair of posts elongated along a length dimension and separated in said width dimension by a first one of said foam blocks; and, wherein each of said posts has a first end contacting said beam and a second end contacting said footing.

In some embodiments said block is hermetically encased by said framework, said footing and said layers.

In some embodiments said component further comprises: said framework having a front surface and a back surface; said first one of said foam blocks having a front face and a back face; wherein said front surface and said front face are coplanar; and, wherein said front surface and said front face are coplanar.

In some embodiments said first one of said foam blocks is shaped and dimensioned to have at least one passageway extending therethrough from said front face to said back face.

In some embodiments said at least one passageway is substantially filled with a plug of cellular concrete contiguously connecting said pair of layers.

In some embodiments said at least one passageway has a substantially cylindrical shape.

In some embodiments said at least one passageway has a cross-sectional diameter of between about 2.5 centimeters and 15 centimeters.

In some embodiments said core further comprises: a lathwork extending over a portion of said front surface.

In some embodiments said framework is a unitary, contiguously poured amount of structural concrete.

In some embodiments said framework comprises bars of reinforcement.

In some embodiments said plurality of foam blocks comprise material selected from the group consisting of expanded polystyrene (EPS) foam, and expanded poly-lactid acid (PLA) foam.

In some embodiments said rigid, closed-cell-type foam has a density of between density of between about 22 kilograms per cubic meter (1.4 pounds per cubic foot) and 48 kilograms per cubic meter (3.0 pounds per cubic foot).

In some embodiments each of said blocks has a surface compressive strength of at least 0.1 megapascal (15 pounds per square inch).

In some embodiments said component further comprises: said structural concrete having an average density of about 2400 kilograms per cubic meter; and said cellular concrete having an average density of between about 400 and 1600 kilograms per cubic meter.

In some embodiments there is provided a component which has been formed into a section of a structure wall or a section of a structure roof.

In some embodiments there is provided a combination of a pair of stratiform layers of cellular concrete straddling a core; wherein said core comprises a framework of structural concrete interspersed with a number of rigid, closed-cell foam blocks.

In some embodiments there is provided a composite foam and concrete building component comprises: a structural concrete layer; a rigid foam layer stratiformly adjacent to said structural concrete layer; a plurality of spaced apart, hollow bulb fasteners, each having an internal chamber; wherein each of said hollow bulb fasteners penetrates through said foam layer and includes a prominence extending into said structural concrete layer; a cellular concrete layer stratiformly adjacent to said rigid foam layer; and, wherein portions of said cellular concrete layer extend into said internal chamber of each of said hollow bulb fasteners.

In some embodiments said structural concrete layer and said rigid foam layer meet at a substantially planar interface surface; and wherein said internal chamber of each of said hollow bulb fasteners extends through a plane coplanar with said planar interface surface.

In some embodiments there is provided a process for forming a composite concrete and foam building component comprises: placing laterally spaced apart blocks of rigid, closed-cell foam between concrete form panels atop a footing; extending a lathwork between said blocks of rigid, closed cell foam to form columnar voids between said blocks of rigid, closed-cell foam; leaving a pair of gaps between said form panels and straddling said foam blocks; first pouring structural concrete into said voids to form posts within said voids and to form a beam capping said posts; second pouring of cellular concrete into said gaps to form layers contacting said posts and said blocks; and, allowing said pourings to cure.

In some embodiments said first and second pouring occur in absence of a movement of said form panels.

In some embodiments said process further comprises placing of spacers between said blocks and said form panels to form said gaps.

In some embodiments there is provided a composite concrete building component comprising: one or more reinforced concrete posts extending laterally across a substantial portion of the width of the composite concrete building component; one or more internal foam blocks disposed between the one or more reinforced concrete posts; a first cellular concrete layer extending across a substantial portion of the width and length of a first side of the composite concrete building component external to a first side of the one or more reinforced concrete posts and the one or more internal foam blocks; and, a second cellular concrete layer extending across a substantial portion of the width and length of the composite concrete building component external to a second side of the one or more reinforced concrete posts and the one or more internal foam blocks.

In some embodiments said component further comprises: one or more form spacers disposed at positions corresponding to locations of the reinforced concrete posts, the one or more form spacers comprising one or more cellular concrete spacers disposed within the first cellular concrete layer and the second cellular concrete layer.

In some embodiments said component further comprises: a first stage of a two-stage window and/or door buck substantially disposed within the internal foam blocks; and, a second stage of the two-stage window and/or door buck substantially disposed within the cellular concrete layers.

In some embodiments the concrete posts and beams and internal foam blocks have been leveled and plumbed.

In some embodiments the composite concrete construction component is a substantially vertical wall.

In some embodiments the composite concrete construction component is configured as a roof.

In some embodiments said component further comprises: one or more channels configured to function as rain gutters disposed adjacent a first edge of the composite concrete building component and extending substantially along the length of the composite concrete building component.

In some embodiments said component further comprises: one or more electrical conduits substantially disposed in the cellular concrete layers; one or more locking bulbs disposed into the internal foam blocks, the one or more locking bulbs filled with cellular concrete.

In some embodiments there is provided a method of constructing a composite concrete building component comprising: setting a first set of one or more form panels to provide a supportive structure for a first side of a composite concrete building component when constructing the composite concrete building component, the one or more form panels extending substantially along the width and length of the composite concrete building component; installing one or more internal foam blocks comprising spaces between individual ones of the internal foam blocks to create substantially vertical voids extending along a substantial portion of the width of the composite concrete building component; setting a second set of one or more form panels to provide a supportive structure for a second side of a composite concrete building component when constructing the composite concrete building component; securing the second set of one or more form panels to the internal foam blocks using a tie and anchor system, the tie and anchor system configured to cause the first and second sets of one or more form panels to compress the internal foam blocks; and, pouring reinforced structural concrete into the voids to create concrete posts and on top of the internal foam blocks to create one or more substantially horizontal beams.

In some embodiments said method further comprises: repositioning the first and second sets of form panels away from the internal foam blocks and reinforced concrete posts to form voids between the internal foam blocks and reinforced concrete posts and the first and second sets of form panels, the repositioning performed after the reinforced structural concrete has sufficiently cured to become self-supporting; and, pouring cellular concrete into the voids between the first and second sets of form panels and the internal foam blocks and reinforced concrete posts.

In some embodiments said method further comprises: removing the first and second sets of form panels after the cellular concrete has cured sufficiently to be self-supporting.

In some embodiments said method further comprises: installing one or more form spacers concurrently with installing the one or more internal foam blocks, the one or more form spacers disposed at positions corresponding to locations of the reinforced concrete posts, the one or more form spacers comprising one or more cellular concrete spacers configured to provide a void between the form spacers and the internal foam blocks; and, pouring cellular concrete into the voids between the form spacers and the internal foam blocks.

In some embodiments said method further comprises: installing, prior to installing the one or more internal foam blocks, a first stage of a two-stage window and/or door buck; and, installing, prior to pouring the cellular concrete, a second stage of the two-stage window and/or door buck.

In some embodiments said method further comprises: installing link cylinders through the one or more internal foam blocks, the link cylinders configured to receive ties for a tie and anchor system.

In some embodiments said method further comprises: levelling and plumbing the reinforced concrete posts, beams and internal foam blocks prior to pouring the cellular concrete.

In some embodiments the composite concrete construction component is a substantially vertical wall.

In some embodiments the composite concrete construction component is configured as a roof component and the method further comprises: providing a plurality of shoring posts and/or trusses, individual ones of the shoring posts and/or trusses having predetermined heights and disposed at predetermined locations to support a roof component.

In some embodiments said method further comprises: installing rain gutter forms prior to pouring the cellular concrete.

In some embodiments said repositioning the first and second sets of form panels away from the internal foam blocks and reinforced concrete posts includes moving the first and second sets of form panels away from the internal foam blocks and reinforced concrete posts.

In some embodiments the composite concrete building component is a basement wall and the method further comprises: installing one or more electrical conduits prior to pouring of the cellular concrete; installing locking bulbs into the internal foam blocks; and, wherein the cellular concrete is poured into the void between the form panels and the internal foam blocks and into the locking bulbs.

The original text of the original claims is incorporated herein by reference as describing features in some embodiments.

### BRIEF DESCRIPTION OF THE DRAWINGS

FIG. 1 is a diagrammatic perspective, partial cutaway view of a composite concrete and foam building component wall according to an exemplary embodiment of the invention.

FIGS. 1A-1D illustrate a first stage of constructing a composite concrete and foam building component wall according to an alternate exemplary embodiment of the invention, in which structural concrete posts and beams are formed.

FIGS. 2A-2F illustrate a second stage of constructing a composite concrete and foam building component wall according to an alternate exemplary embodiment of the invention, in which cellular concrete layers are formed.

FIGS. 3A-3N illustrated an insulated concrete roofing system using a composite concrete and foam building component according to an exemplary embodiment of the invention.

FIGS. 4A-4D show a ribbed plastic form panel according to an exemplary embodiment of the invention.

FIG. 4E shows plastic inside comer form according to an exemplary embodiment of the invention.

FIGS. 5A-5B show a steel shoring post and walking plank for a plumbing and bracing system according to an exemplary embodiment of the invention.

FIGS. 6A-6D illustrate a fiberglass tie rod and anchor system according to an exemplary embodiment of the invention.

FIGS. 7A-7B illustrate quick release pliers for releasably connecting to the tie rod and anchor system according to an exemplary embodiment of the invention.

FIG. 7C illustrates a removable box truss according to an exemplary embodiment of the invention.

FIGS. 8A-8J illustrate a composite concrete and foam building component basement wall using an internal hollow bulb adhering system according to an exemplary embodiment of the invention.

FIGS. 9A-9M illustrate a form spacer and method of use in constructing a composite concrete and foam building component according to an exemplary embodiment of the invention.

Like reference symbols in the various drawings indicate like elements.

### DESCRIPTION OF THE EXEMPLARY EMBODIMENTS

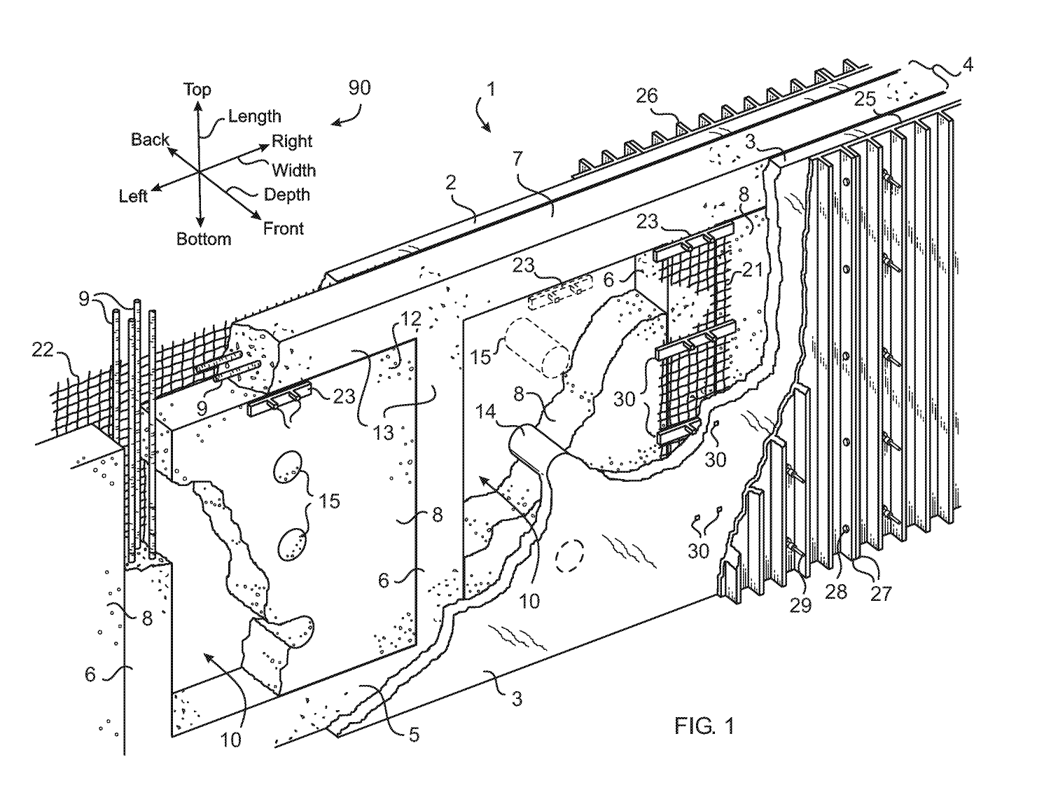

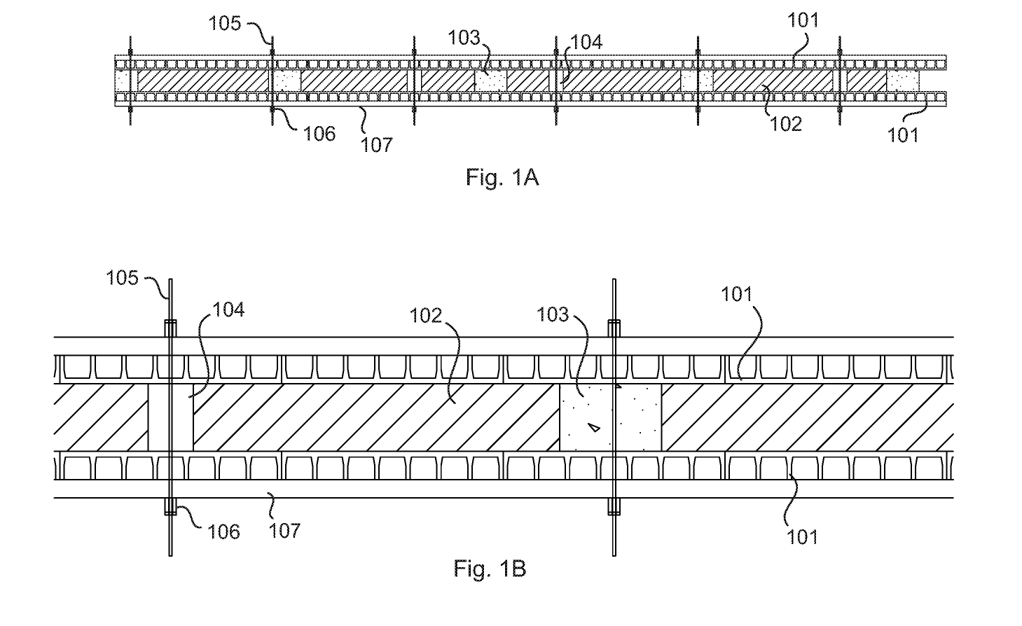

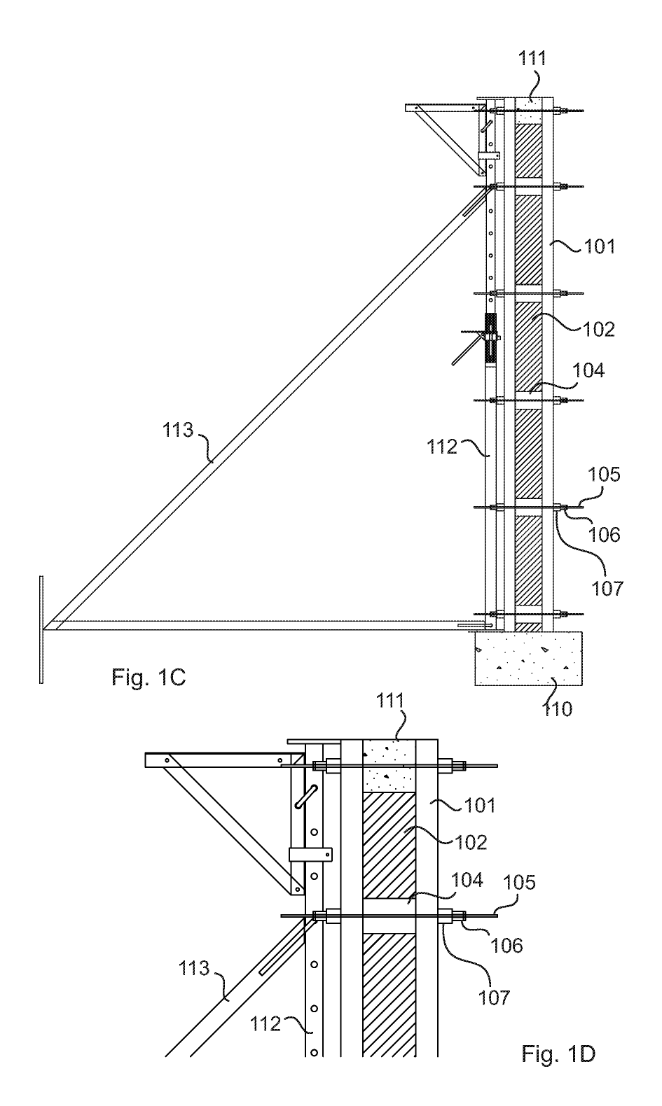

Referring now to drawing, there is shown in FIG. 1 an exemplary embodiment of a composite concrete and foam building component 1. The composite concrete and foam building component will be described by way of example as a substantially vertical, planar, load-bearing peripheral wall intended for a single-story, single-family-type home. Those skilled in the art will readily appreciate the applicability of the building component to other parts of the home such as the roof, and other types of permanent or semi-permanent structures requiring insulation. A dimension and direction reference frame key 90 is provided to aid in keeping track of the length, width and depth dimensions used, and their associated relative directions, namely, top and bottom, left and right, and front and back typically associated with building a wall. Those skilled in the art will readily appreciate translation of the invention to other frames of reference for building other structures.

As shown in FIG. 1, the composite concrete and foam building component 1 has front and back stratiform layers of cellular concrete 2,3 straddling a central core 4 including a structural concrete framework of substantially vertical posts 6 supporting a substantially horizontal beam 7 enwrapping blocks 8 of insulating, rigid, foam. The structural concrete framework is employed to handle the structural loads, including shear and seismic considerations. The cellular concrete is employed to handle the wall surface integrity and insulating properties, providing a very high R value in combination with the internal foam blocks. When forming a wall, the central core and cellular concrete layers can be supported upon a structural concrete footing 5.

The central core 4 of the a composite concrete and foam building component 1 includes the structural concrete framework set atop a structural concrete footing 5. The framework can include an oblong, substantially horizontal beam 7 supported atop the first, top ends of a number of oblong, substantially vertical posts 6. The posts are supported at their second, bottom ends upon the footing 5. Thus, the framework can be composed of a number of mutually orthogonally interconnected oblong members. The posts are laterally spaced apart to form spaces 10. The footing, beam and posts can be reinforced with strands 9 of steel rebar, confinement ties or other reinforcing material. It shall be understood that when the composite concrete and foam structural component is used as a roofing panel, the footing may be replace by a beam or other oblong, structural concrete support structure or structures.

Blocks 8 of insulating, rigid, closed-cell foam material such as made from expanded poly-lactid acid (PLA) foam, commercially available under the brand name Biom or BioFoam from Synbra Technology by of Etten-Leur, The Netherlands or expandable polystyrene (EPS) foam commercially available from that same company, can be interspersed within the spaces 10 formed between the posts 6, the beam 7 and footing 5. It is preferred that the block have structural properties which will allow the blocks to act a forms during the pouring of the structural concrete framework and the cellular concrete layers. In other words, the foam should have sufficient strength and hardness to resist significant deformation under the force of the poured concrete. Other rigid, closed-cell foams exhibiting the necessary physical properties such as various natural polymer-based foams, synthetic polymer-based foams, and other natural plant-derived hydrocarbon based foams may be used.

Preferably, the blocks have a density of between about 22 kilograms per cubic meter (1.4 pounds per cubic foot) and 48 kilograms per cubic meter (3.0 pounds per cubic foot). It has been found that lower density foam can have greater insulating properties, but can consequently have poorer structural properties. The blocks should have a compressive strength of at least 0.1 Mpa (15 pounds per square inch), otherwise additional structural support for the poured concrete may be necessary depending on the design.

The substantially planar front face 12 of each of the rigid foam blocks 8 can be substantially coplanar with the substantially planar front surface 13 of the posts 6 and capping beam 7. Similarly, the structural concrete framework of posts and beam, and the rigid foam blocks can have a substantially planar back surface and faces, respectively, which can be substantially coplanar. The substantially coplanar front faces and surface form a substantially planar front side of the core 4. The substantially coplanar back faces and surface form a substantially planar back side of the core. The front and back sides of the core can thus be parallelly spaced apart.

The front and back sides of the central core 4 are covered by layers 2,3 of cellular concrete. In this way the foam blocks are entirely encapsulated with concrete, and thus hermetically encased by the concrete. The front and back layers of cellular concrete can be interconnected and bonded together by a number of plugs 14 of cellular concrete contiguously linking the front and back layers of cellular concrete through the foam blocks 8. Each plug can be formed by one of a number of passageways 15 extending through the entire depth dimension of the respective foam block. The passageways can be cylindrically shaped so that the plugs form link cylinders between the cellular concrete layers. Cylindrical passageways can have a diameter of between about 2.5 centimeters (1 inch) and 15 centimeters (6 inches). Expanded metal lath can be inserted to support the passageways until they are inundated with cellular concrete.

An expanded metal lathwork 21 can be extended over the front and back surfaces of the posts 6 to aid in their being formed when the structural concrete is poured. Although an additional amount expanded metal lath 22 can be used as a form along the length of the beam 7, it has been found than a pair of wooden boards such as 2×6 boards can be supported atop a set of upper spacers 23. Once the structural concrete has hardened sufficiently, the boards can be removed below and the cellular concrete poured. The spacers are used to space the front and back rigid, ribbed, plastic forms 25,26 apart from the core to form gaps into which the cellular concrete will flow. Once the cellular concrete has hardened sufficiently, the forms can be removed.

Each of the rigid, ribbed, plastic forms 25,26, which span the length and width of each of the front and back sides of the wall, can be created by a number of form panels 27 connected to one another along the abutting lateral edges using removable fasteners 28. The form panels are spaced apart from the core 4 by the upper spacers 23 and other spacers 30. The form panels are held in place during the pouring of concrete by bracing and/or shoring (not shown), and an anchor tie system using an array of anchor ties 29 which releasably connect the front and back form panels to one another. The form panels, anchor tie system, spacers, bracing and shoring systems will be described in greater detail in connection with another exemplary embodiment described below.

In this way the formwork can be placed in one step. There can be a significant advantage in labor costs when there is an absence of movement, in other words no repositioning, of the form panels between pourings of the structural concrete and cellular concrete.

Thus, the composite concrete and foam building component can be created by placing laterally spaced apart blocks of rigid, closed-cell foam between concrete form panels atop the footing being careful to leave a pair of gaps straddling the front and back sides of the foam blocks which leave room for the cellular concrete layers to be later poured. Lathwork can be extended between the foam blocks to form columnar voids between the blocks for forming posts. The lathwork can be extended upward form the blocks to create formwork for the front and back surfaces of a beam capping the posts. Alternately, a pair of forming boards can be rested atop spacers located along the top of the foam blocks and have a depth spacing selected to accommodate the depth of the beam. A first pouring of structural concrete into the voids and between the extended lathwork (or boards) to form a beam and posts. A second pouring of cellular concrete into the gaps forms layers of cellular concrete contacting the posts and blocks. Once the concrete is cured, the forms can be removed.

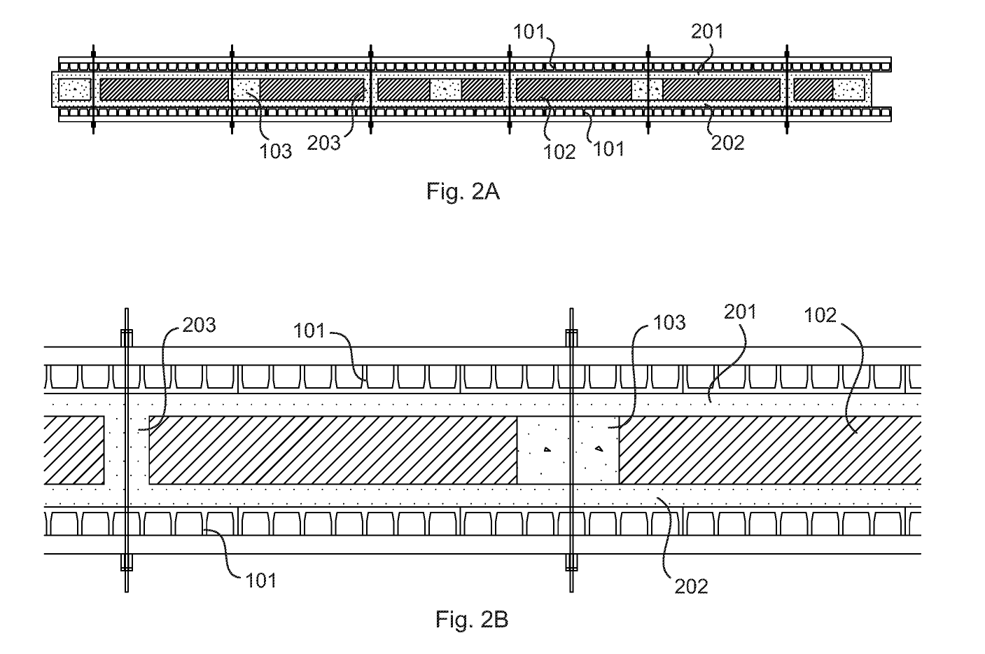

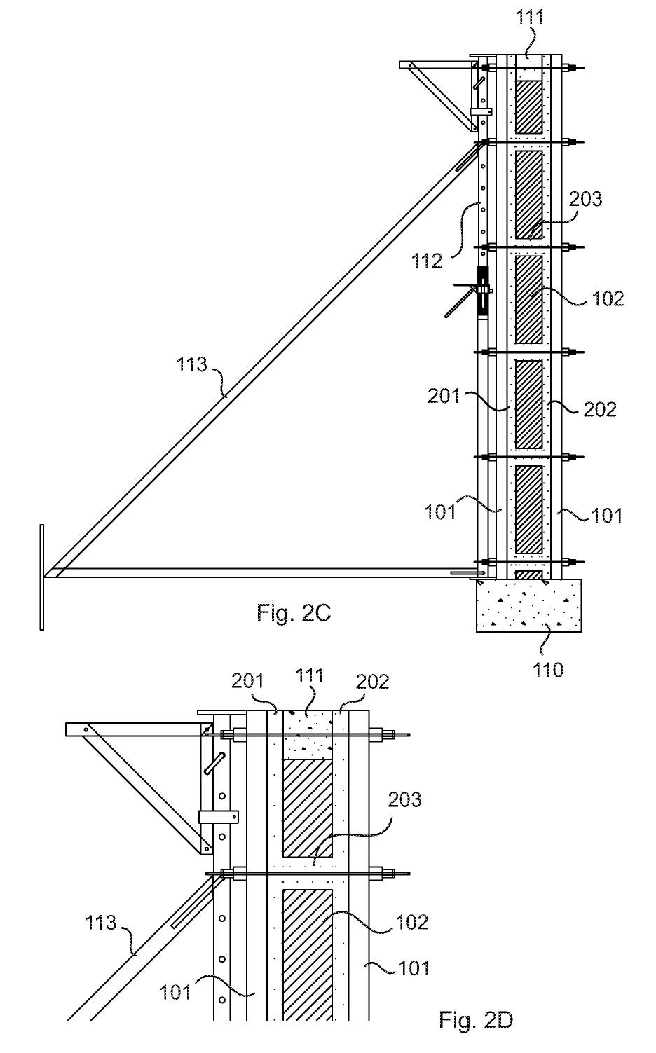

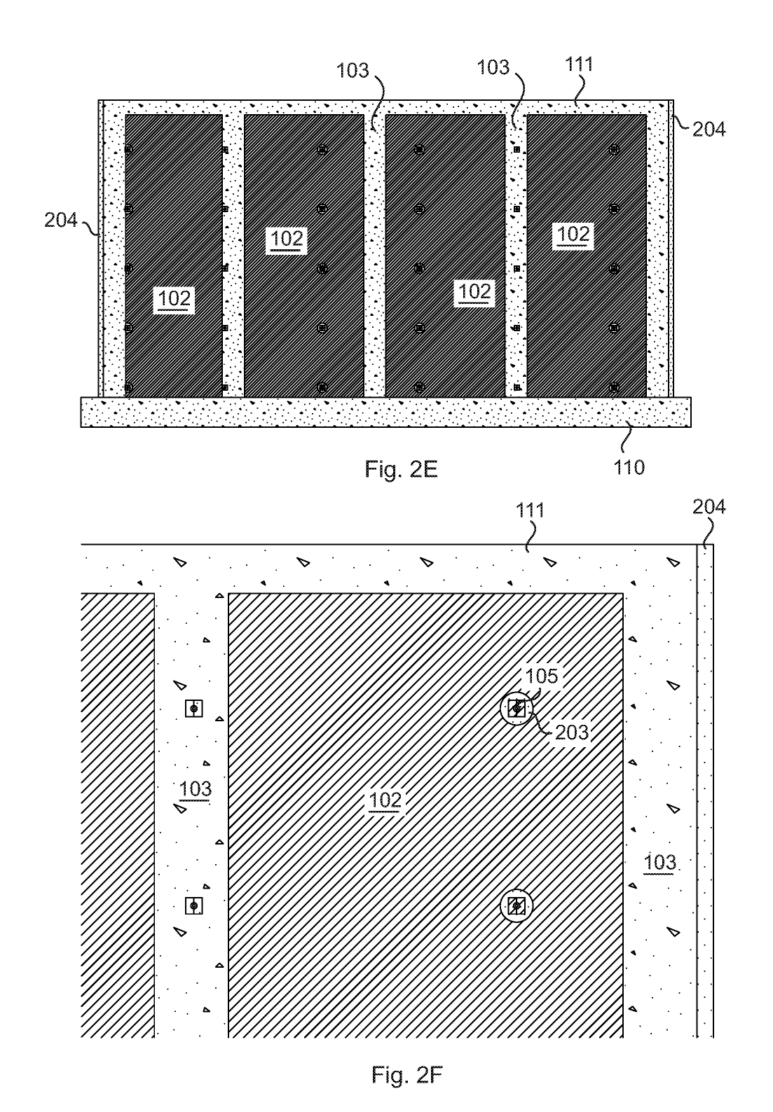

Referring now to FIGS. 1A-1D and 2A-2F, there is shown an alternate exemplary embodiment of a composite concrete and foam building component utilizing the invention. The walls are part of a two-part building system that combines structural concrete and cellular concrete with blocks of rigid foam. As with the previous embodiment the structural concrete is employed in a post and beam system to handle the load, shear and seismic issues and considerations. The cellular concrete handles the wall surface integrity and insulating properties, providing a very high R value.

Forms are used for the forming of walls. The forms can be made of plastic or other rigid material.

Upon removing the forms, the outside and inside walls can be completely smooth, and ready for a texture or plaster to be applied. In some implementations, however, the form for the outside and/or inside wall can be provided with a texture or pattern, such as a brick pattern or wood shingle pattern, for example. Alternatively, the texture or plaster can be applied to a smooth wall and can be patterned thereafter.

In some implementations, pour-in-place-type, plastic, watertight forms are used in a two-step process. The first step, as shown in FIGS. 1A-1D, is to place the forms for constructing the post, beams and headers that act as the skeleton in the construction system. The wall forms, i.e. inside form and outside form, are set into place one at a time. Rigid, closed-cell foam panels blocks, made from a material such as EPS foam, can be attached onto one side of one of the wall forms at spaced intervals, such as every 1.5 meters (5 feet), to allow for a space between each block of foam for the formation of posts. The space can be 15 centimeters (6 inches) to 30 centimeters (12 inches), and preferably 22 centimeters (9 inches). The space creates a void that is filled with structural concrete to create the post and beam system. Fiberglass 0.8 centimeter ( 5/16 inch) rods are pushed through the forms and foam, and are attached to the second form that is assembled flush against the foam. Rebar is placed within voids left by the foam and tied in with the foundation. Helix and/or synthetic micro rebar is added to the mix for added strength. The form panels are tightened down onto the foam, producing a water tight seal. Space is left inside for windows, door headers and top beams that run the horizontal length of the wall. Rebar is placed within the wall posts, beams and headers with plastic rebar holders and tie cradles, which makes structural concrete placement fast and easy. These plastic ties are imbedded into the concrete. The 23 centimeter (9 inch) post configuration can be different depending on the specifications that are required by engineering on each individual structure, and is described as an example only.

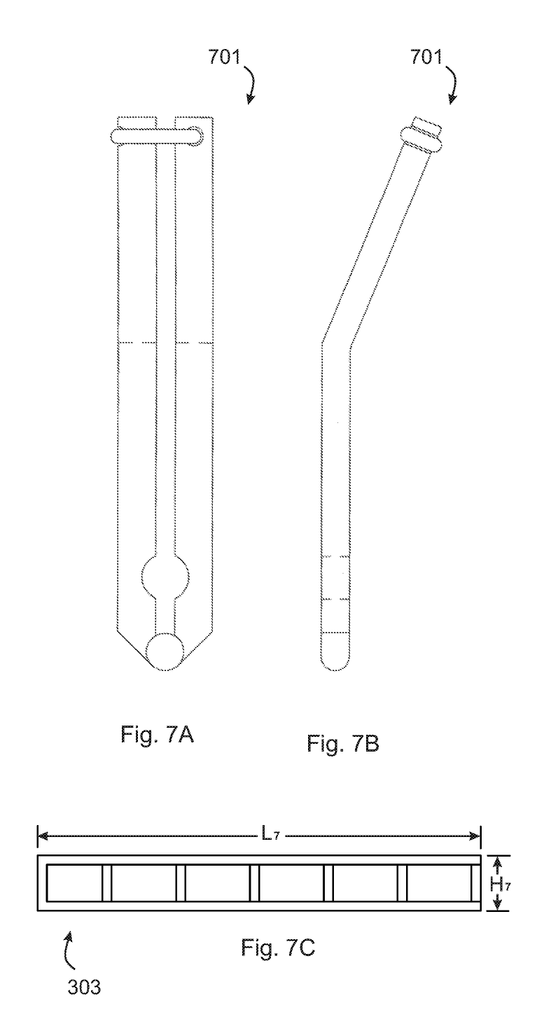

After the initial structural concrete pour, the next step, as shown in FIGS. 2A-2F requires the forms to be moved out from the foam blocks and structural concrete (and from each other) about 2.5 centimeters (1 inch) to about 7.6 centimeters (3 inches) depending on thickness requirements of walls from engineering specifications. Rigid rods, such as 0.8 centimeter ( 5/16 inch) fiberglass rods, can be used in the forming system, and can be imbedded into the structural concrete to connect both sides of the walls together. A set of quick release pliers, as shown in FIGS. 7A-7B, are used to connect the rods to the wall form surface and can be removed easily, by unclamping, when the forms are to be moved outward for the second pour, or the pour of cellular concrete.

In some implementations, each foam block, can have the same thickness as the structural concrete posts and beams, and include a number of passageways through it. The passageways can be rounded or squared, and range from 2.5 centimeters (1 inch) to 15 centimeters (6 inches) in diameter. The passageways are preferably straight through the foam, but can be angled into the foam. The passageways are provided at spaced intervals in the foam, to allow the cellular concrete to connect both wall surfaces for extra strength. This process creates a wall that is extremely lightweight, waterproof and very strong. Fibers are added to the cellular concrete which gives it a micro rebar effect, thus adding extra strength all throughout the mix. A chemical can be added to thicken the cellular concrete so it can be pumped in a more manageable consistency. Heavy water can also be added to the cellular concrete mix. This keeps the cells or bubbles intact, and adds to overall quality and overall structural integrity of the wall surface. This system and process eliminates the need for wood, drywall, insulation and stucco, greatly reducing complexity and costs, and providing greater strength and durability.

Plastic or other rigid material window and door bucks are used to form cavities where the windows and doors will be located. In some implementations, the system employs a stay-in-place plastic form that has spacers applied to it when the walls are relocated outward for the second pour. There are two kinds of spacers that are possible. One is made from 18 mm very strong cloth infused with plastic, the other is a plastic cap system. The plastic fabric is folded together for the first pour. When the forms are moved out for the second pour the fabric unfolds is unfolded. After the cellular concrete has cured and forms removed, the windows and doors can now be slid into this finished surface, screwed and sealed into place. By having a smooth mounting surface for the windows and doors, labor time and costs are significantly reduced as there is no stripping of the window and door buck forms, then having to trim out the windows and doors with other materials. The basic door and window buck system is put into place for the first pour of structural concrete. When the forms are moved, out a plastic cap is snapped into place over the original part that has a 5 cm (2 inch) to 7.6 cm (3 inch) spacer on each side. When the cellular concrete is pumped in, it makes a perfect seal onto the bottom of this plastic cap surface. When the forms are removed, there is a smooth flush mounting surface for the windows and door frames. An accordion type fabric spacer may also be used.

The structural concrete top plate beam is configured to intersect the main beam that forms the roofing system. Rebar is extended out of the top plate and connects to the roof beams that intersect the main beam that runs from one end of the house or room to the other. The same forming system used for the walls are now reconfigured and used for the roof. The roof can have multiple pitches from flat to 8 in 12 or whatever the engineering dictates depending on the building requirements.

In some implementations, the forms are put up with shoring and held up by an adjustable truss system. The bottom structure of the form is erected and the top form is left off for the first pour. This is also done in a two-step process similar to the walls. The difference is that the roof can be formed at a pitched angle to achieve gables and overbuilds.

The foam block is put down on the bottom forms and spaced apart to create a void that will allow the rafters to be formed between the EPS foam pieces. Structural concrete is pumped into the voids and then allowed to cure, resulting rafters that are structurally sound to withstand seismic and snow loads. In some implementations, the spacing between the foam blocks can be 15 centimeters (6 inches)×15 centimeters (6 inches), however the spacing, and therefore cross sectional area of the rafters, can be any of a variety of dimensions.

The bottom form holds up the beams that are now structurally able to support the roof load. Foam is used for the forming and is held up by small blocks of cellular concrete or plastic spacers that stay imbedded in the ceiling after the lower form is removed. The top plate of plastic forms are laid over the rafters and held up by special plastic spacers that are connected to the rafter and stay inside the cellular concrete roof structure. These forms are about 10 centimeters (4 inches) above the rafter beams and EPS foam. Passageways are drilled into the EPS foam closer together than the wall forms, such as about one to two feet apart, so the top roof surface can intersect and connect to the ceiling below. This structurally holds the top and bottom cellular concrete surfaces together. The forms are set up or shaped with rain gutters and eves molded into the roofing system. After the forms are set in place and anchored, the leak proof forms are filled with cellular concrete. Special additives can be put into the cellular concrete to make it waterproof, strong, lightweight and to speed up the curing time. These chemicals also keep the concrete from cracking, along with special fibers that can be added for strength. Upon removing the forms, a smooth ceiling with a very high fire rating is created. Now the ceiling surface is ready for the final plaster coat. On the top side, the smooth waterproof roof is now ready for one of a number of possible finishes. Finishes include stamping of shingles, or other textures made from special cement and mortar. The application of fireproof lightweight fiberglass tiles or ceramic tiles may also be installed as an alternative and can give the building a Spanish style look. The roof is extremely strong and can handle heavy snow loads and is highly rated for seismic strength.

The cellular concrete gives the structure a very high insulating factor, while still allowing the wall surfaces to be formed 5 centimeters (2 inches) thick. This creates the feel of finished drywall or plaster. Nails and screws can be easily inserted and will hold solid as in wood. Foam air added to the concrete makes it waterproof, fireproof and highly insulative. Low thermal conductivity is equivalent to high insulating capability (R-value).

The building system as described herein provides composite concrete and foam building component panel formed in place that is structurally sound, fireproof, lightweight, waterproof, earthquake resistant, wind resistant, and incorporates EPS foam in between the wall layers for a relatively high R value rating. By placing passageways into the EPS foam, the cellular concrete can flow between layers during pouring and thus locking the inside and outside cellular concrete wall layers together with the EPS foam sandwiched in between. This process assures the walls' integrity and no delaminating of layers can occur.

The system replaces the need for ICF blocks or standalone aluminum forms, is less expensive and much faster and easier to install than conventional construction methods. The system replaces the need for wood, insulation, drywall and other materials, while creating a much stronger, long-lasting structure that is virtually indestructible. The savings over “stick” built structures is around 10 to 30% depending on geography.

FIGS. 1A-1D illustrate a first stage of constructing an insulated concrete wall system, in which posts and beams are formed. To lay out the dimensions, of an area bounded by one or more walls of the wall system, a chalk line can be used to mark on footings 110 where the outside/inside edge of forms should be placed. Next, the form panels 101 are set. One side of the wall forms is set according to the engineered plan and in conjunction with layout lines on footings. Two stage window and door bucks are placed as per plan detail. Internal foam blocks 102 are placed using “spacers” between foam blocks to create a void which will become a post 103, i.e. a conduit into which structural concrete can be poured. The void can be at least partially filled with rebar or other structures to maintain structural integrity. The internal foam blocks are placed at a height equal to the bottom of the structural beams 111. Link cylinder passageways 104 are placed as required. The other side of the form panels are set using a tie and anchor system including fiberglass tie rods 105 and tie rod anchors 106 and support struts 107 (referred to hereafter) compressing the internal foam blocks. A shoring system including shoring posts 112 and braces 113 help hold the formwork in place. Reinforced structural concrete is then placed in or poured into the voids created by the “spacers” between internal foam blocks, creating substantially vertical posts, and on top of the internal foam blocks, creating substantially horizontal beams.

FIGS. 2A-2F illustrate a second stage of constructing an insulated concrete wall system, in which cellular concrete layers 201,202 are formed. First, in some implementations, the form panels 101 are repositioned (interior and exterior). They can be repositioned, i.e. further spaced apart both from each other and the wall of foam 102 interposed with structural concrete posts 103, by any distance from 1.25 centimeters (0.5 inch) to 15.25 centimeters (6 inches) or more. In some preferred exemplary implementations, each of the internal and external forms is repositioned away from the foam/structural concrete by about 5 centimeters (2 inches). Structural concrete is hardened and cured enough to be self-supporting.

In an exemplary implementation, first the interior form panels 101 are moved out 5 centimeters (2 inches). Stage two of interior window and door bucks are installed proximate the interior foam block. Then the exterior form panels are moved out 5 centimeters (2 inches), and stage two of exterior window and door bucks are installed proximate the exterior form panels. The tie rod 105 and anchor system is repositioned, as shown. The wall can be leveled and plumbed.

Then, cellular concrete 204 is poured into the gaps between the forms and the foam/structural concrete wall, through the link cylinder passageways in the foam, and around the interior and exterior window(s) and door buck(s), if any. Cellular concrete should flow at a consistency of pancake batter, allowing it to flow through internal foam blocks filling both interior and exterior layers 201,202 and linking both layers together through link cylinders 203.

Next, the form panels 101 are removed, leaving the foam/structural concrete wall encased on either side by hardened, cured cellular concrete. The interior and exterior wall surfaces are touched up using a masonry block as a sanding block to remove any ridges created by joints of interior and exterior form panels, and are then ready for any of a number of finishing processes.

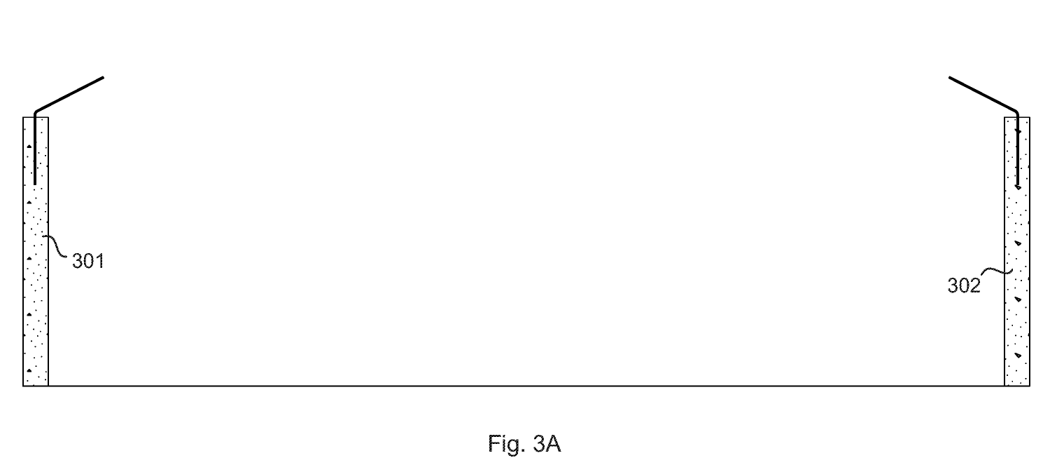

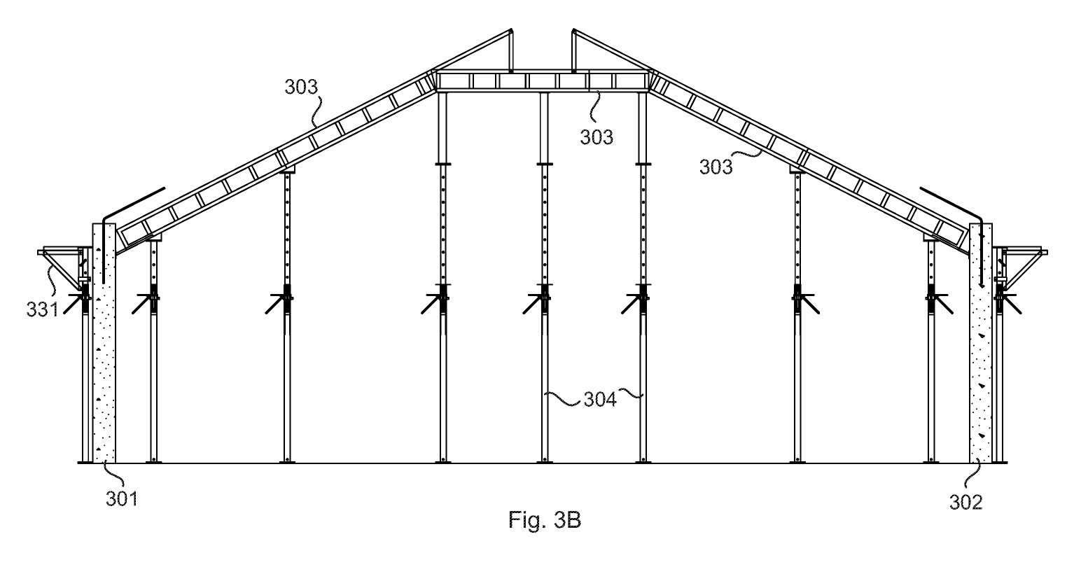

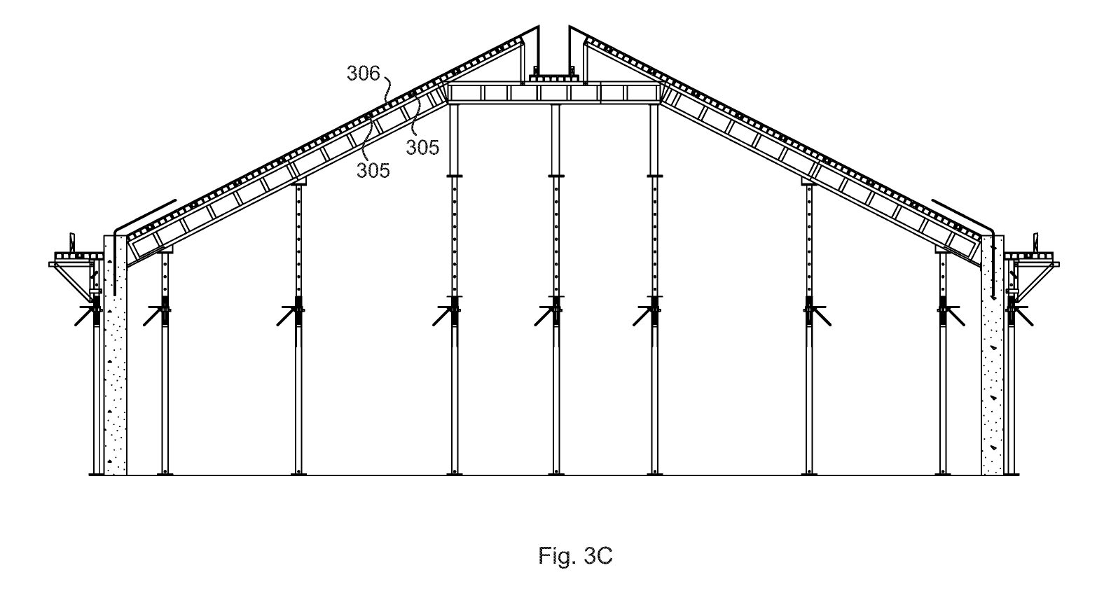

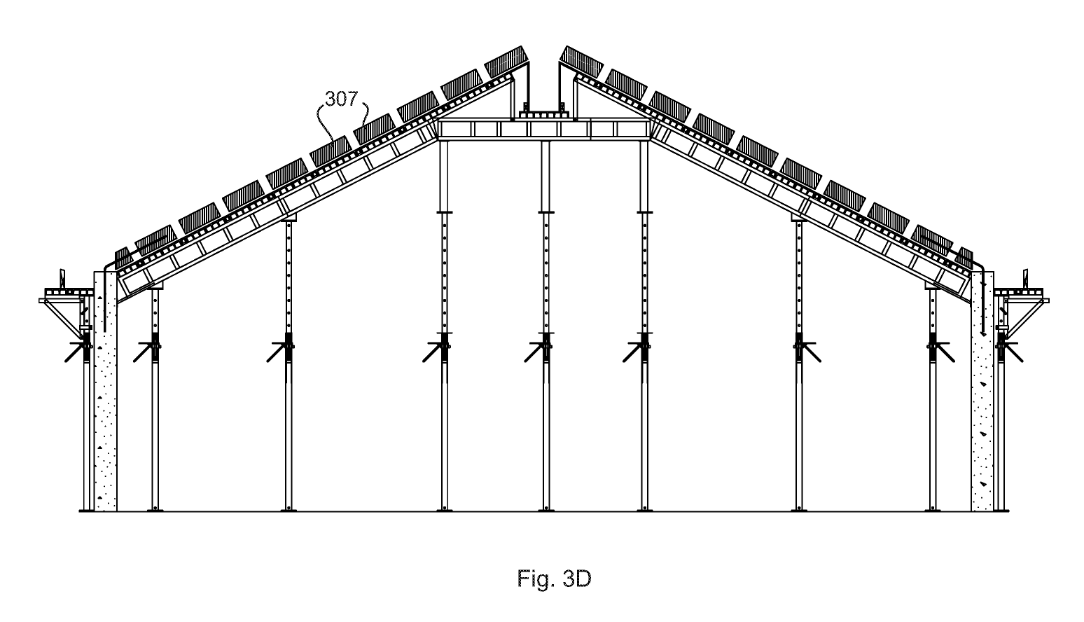

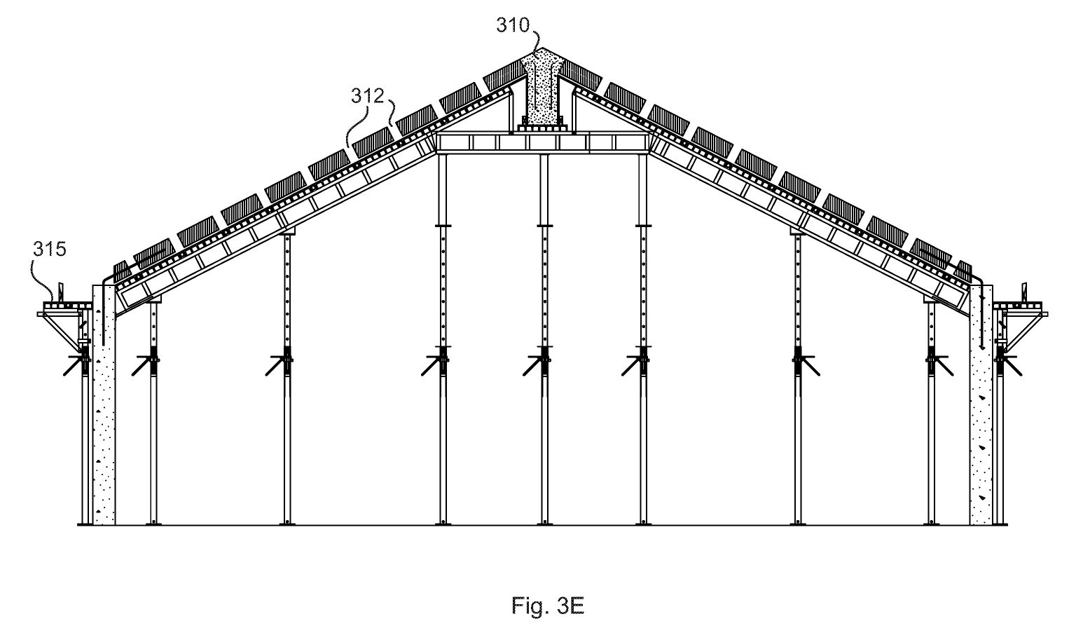

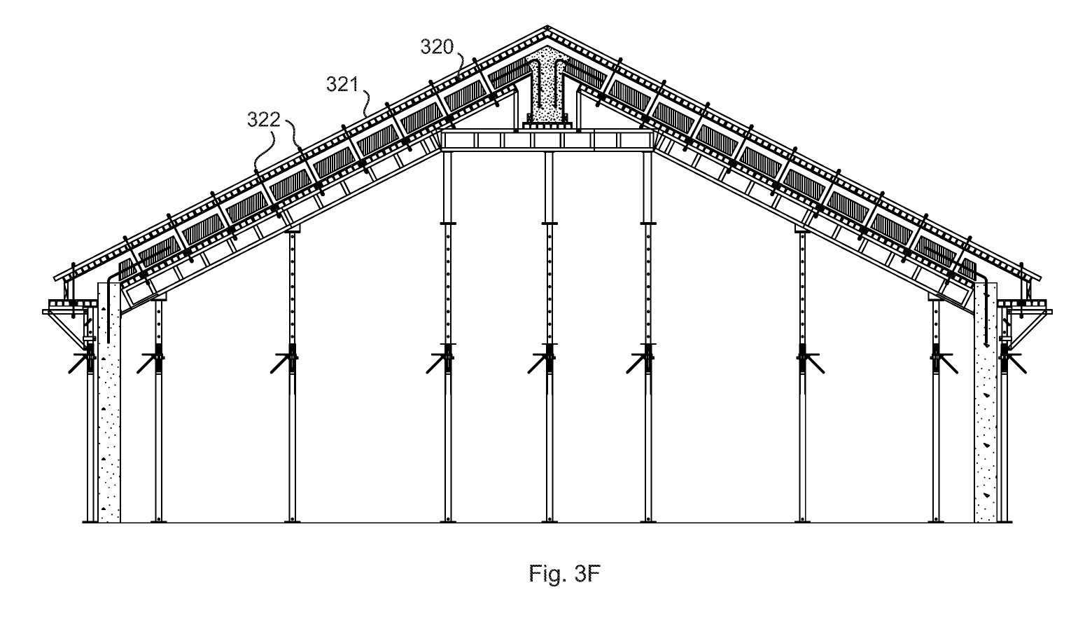

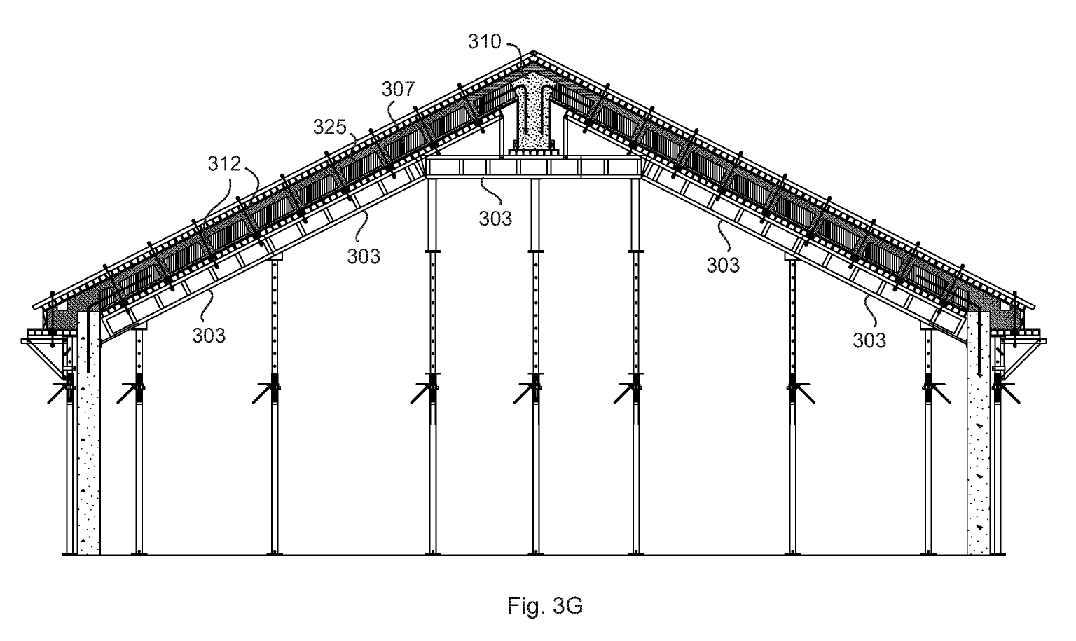

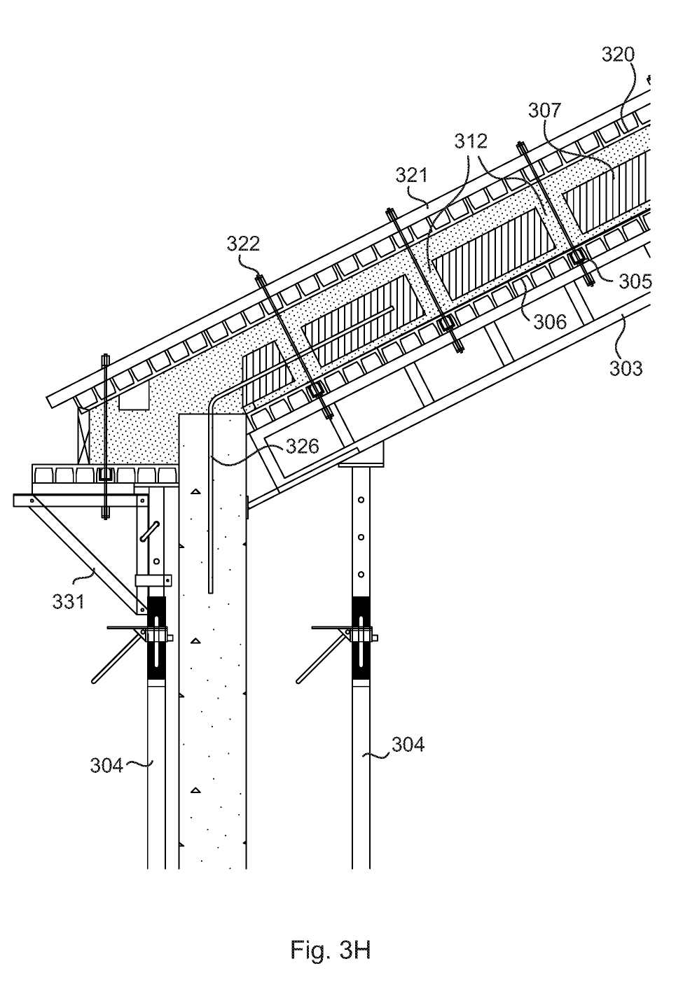

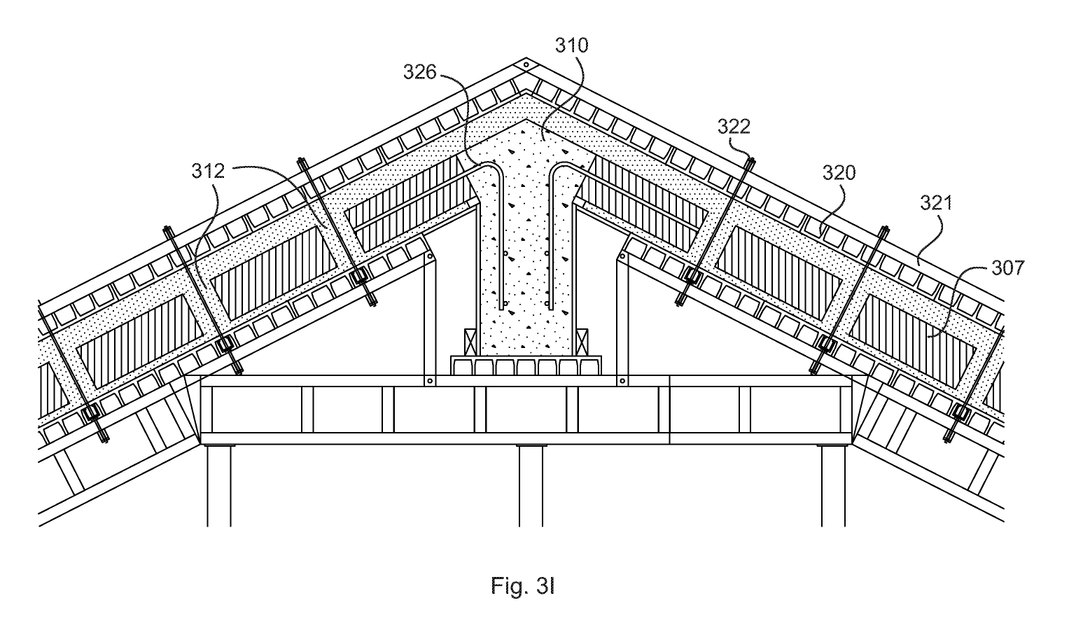

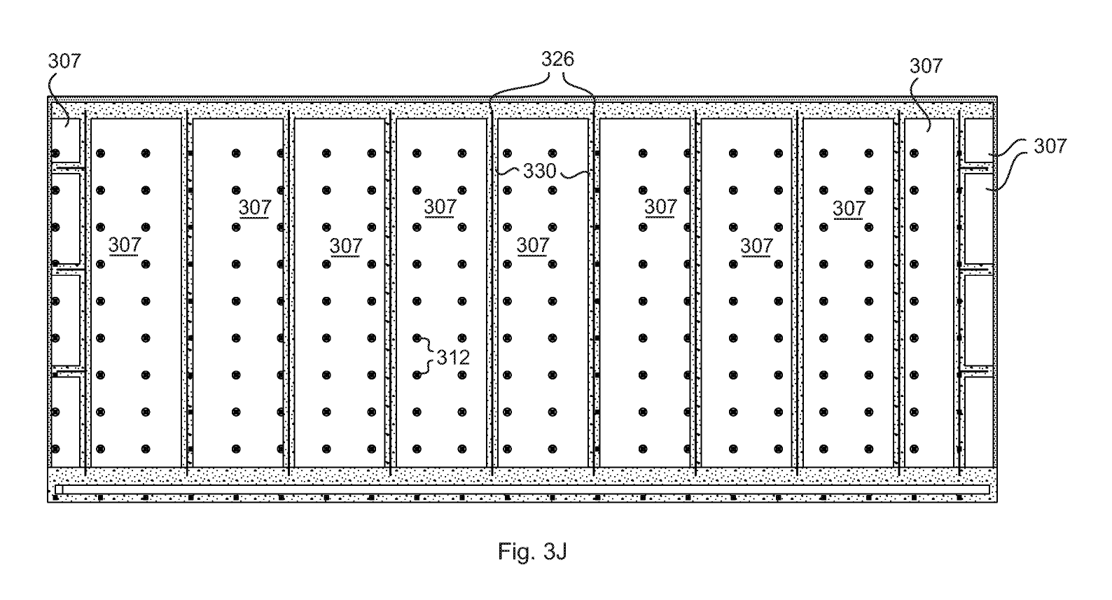

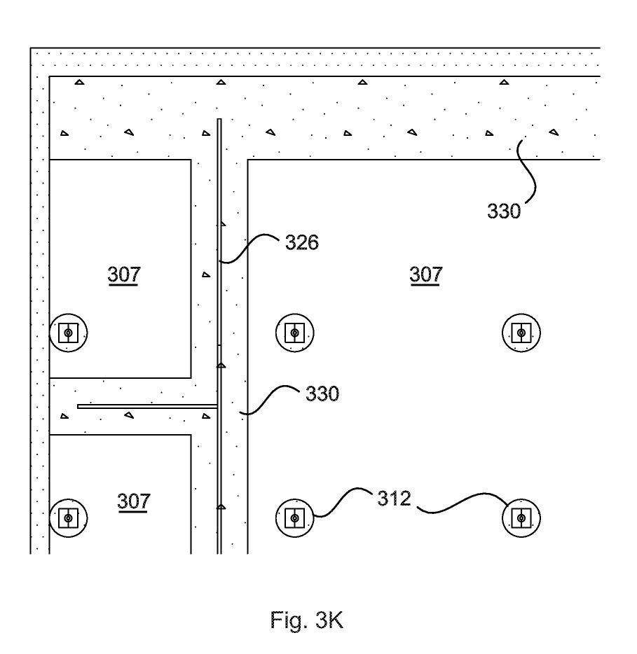

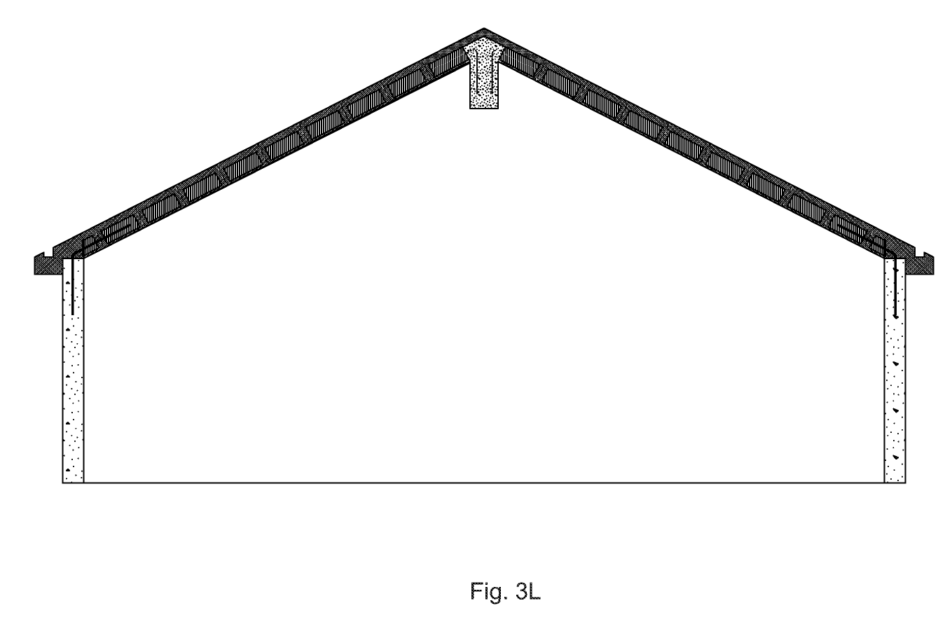

Referring now to FIGS. 3A-3N, there is shown a composite concrete and foam building component utilized in an insulated concrete roofing system.

As shown in FIG. 3A, concrete walls are completed and cured.

As shown in FIG. 3B, shoring posts 304 and trusses 303 are set at a preset locations that work with engineered plans. An eave shoring bracket 331 is also placed.

As shown in FIG. 3C, supporting strut purlins 305 are set on top of trusses on a preset layout. Ribbed plastic bottom form panels 306 are set on top of the purlins. Spacers are set on top of bottom plastic panels, leaving a space for cellular concrete to flow.

As shown in FIG. 3D, foam blocks or sheets 307 are placed in a manner to leave the void defined by the spacers, to form beams of re-enforced structural concrete. Beam layout must be in line with posts and reinforcement bar in cured walls. Reinforcing bar is placed in structural beams. Then, a fiberglass tie rod anchor system is set from the bottom of the purlins, and fasteners are placed on top of the foam sheets (to hold foam sheets in place as structural concrete is placed).

Next, as shown in FIG. 3E, structural concrete 310 is placed or poured in the gaps, forming beams 330 (not shown in FIG. 3E). The structural concrete is allowed time to harden and cure.

Spacers for cellular concrete are placed on top of the hardened structural concrete and the exposed top sides of the foam blocks. Link cylinder passageways 312, formed through the foam blocks, will enable cellular concrete to flow from bottom to top between plastic forming systems, thereby linking the top and bottom cellular concrete layers together. A house wrap gasket is placed on top of the lowest form of the bottom of the plastic form panels and run down over the eve and up to the first plastic form panel on top. A rain gutter/drainage support form can then be installed atop the peripheral shoring.

As shown in FIG. 3F, top form panels 320 are placed on top of the spacers, and a shoring system 321 is set on top of the top of the form panels. Tie anchors 322 are set.

Next, as shown in FIGS. 3G-3I, cellular concrete 325 is placed or poured, flowing through link cylinder passageways 312 encapsulating the foam blocks 307 and structural beams 310. The structurally reinforced concrete walls 301,302 support reinforcement bars 326 which extend from the walls to engage structural concrete beams 330 in the roof. The roof beams are interspersed with blocks 307 of rigid, insulating foam material such as EPS.

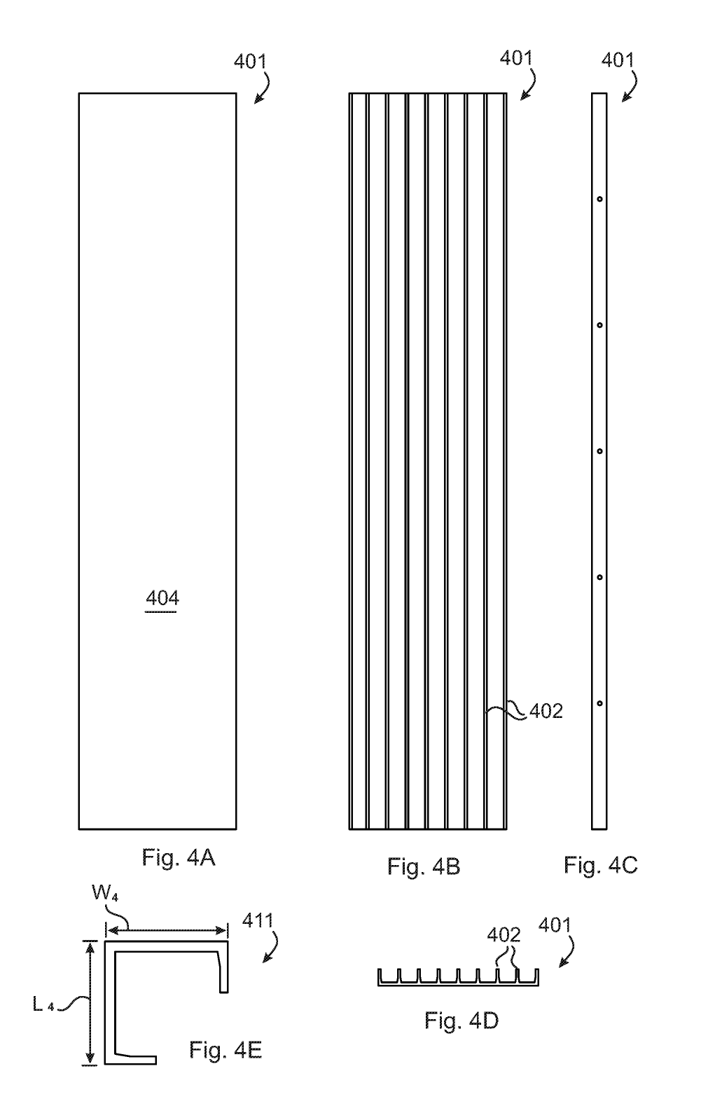

After the concrete has gained sufficient strength, all forms and shoring are removed. FIGS. 4A-4F show a ribbed plastic form panel 401 and inside corner form 411. Each panel has a substantially smooth planar front surface 404 for contacting the concrete. From the back surface extends a number of parallelly spaced apart ribs 402 which are used to create strength and rigidity. A preferred spacing S₄ for the ribs in a panel typical to home-building applications is about 7.5 centimeters (3.0 inches). The rib can be spaced in a manner that allows the form panel to be cut down to create multiple sized forms. Side-adjacent panels can connect to one another by engaging fastening holes 403 through the laterally outer-most rins or through other common means. Inside corner forms 411 are manufactured with multiple ribs. The plastic form panels can be extruded in any length, up to 12 meters (40 feet) or more. A preferred cross-sectional size typical to home-building applications is about 15 centimeters (6 inches) in both length L₄ and width W₄ dimensions. The plastic form panels can be manufactured out of many different densities of plastic to adjust weight and strength. The ribs have a cross-sectional shape having a gradually widened base to improve strength while reducing material.

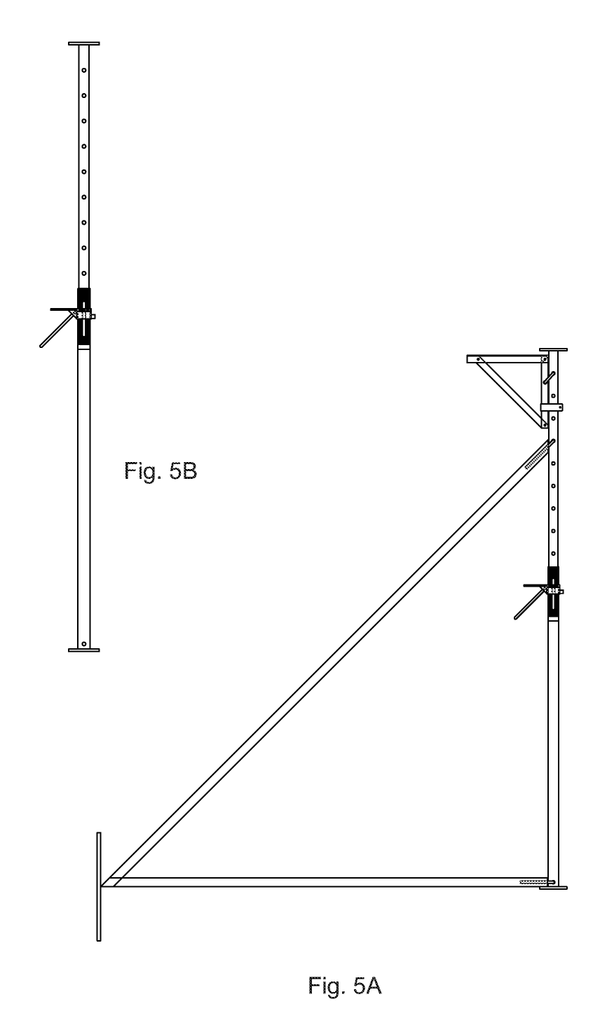

FIGS. 5A-5B show a system and method utilizing a steel shoring post and walking plank for a plumbing and bracing system. The steal shoring post can be a standard off-the-shelf item, and is used in both the construction of the walls and the roofing system. The walking plank is attached to the top of the shoring post using holes, which are punched in the top of shoring post. A pin or other elongated member is used to secure the walking plank to the shoring post and hold the walking plank in position. The plumbing and bracing system is secured to the shoring post below the walking plank in one of the holes which is typically present from the original manufacturer. The plumbing and bracing system is also secured to the shoring post at the base of the shoring post in order to hold the post in position.

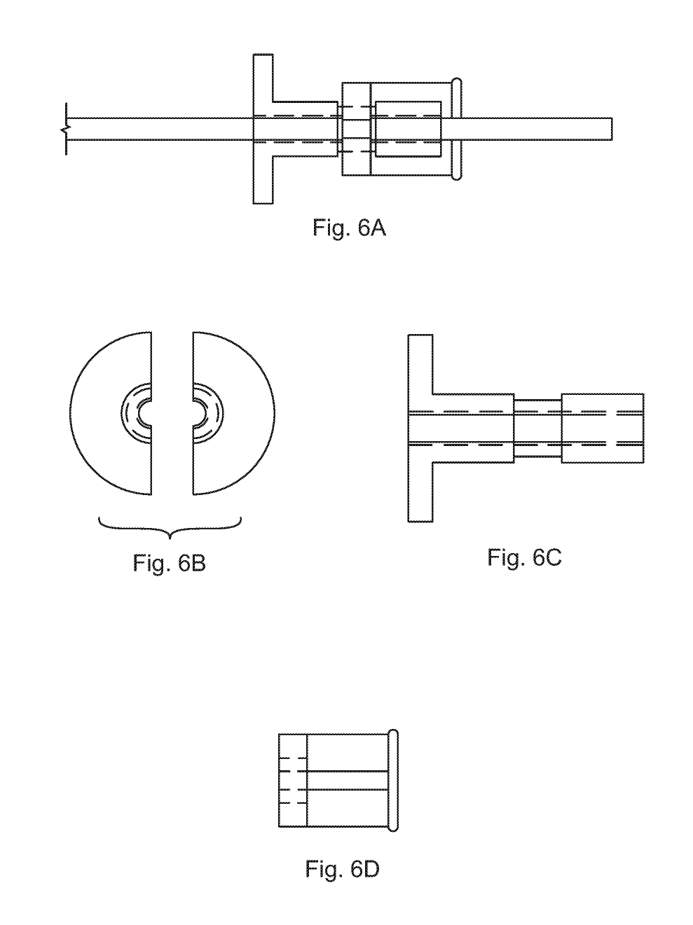

FIGS. 6A-6F illustrate a fiberglass tie rod and anchor system and method for using the same. While fiberglass is a suitable and preferred material for the tie rod, other materials can be used. The fiberglass tie rod and anchor system provides a tie system which, when the forms are stripped or removed, leaves a surface that will show no degradation over time, and is not affected by moisture conditions. The fiberglass tie rod and anchor system works in conjunction with the plastic form panels and vertical shoring system. The anchor system has three parts. Two of the three parts are in direct contact with the fiberglass rod. The third part is used to compress the first two parts (identical parts) and secure them in place. The anchor system is configured to be used multiple times on the same fiberglass rod, releasing the rod on demand and re-anchoring in multiple positions, and is designed to be reused for multiple projects.

FIGS. 7A-7B illustrate a set of quick release pliers 701, as shown in are used to connect the rods to the wall form surface and can be removed easily, by unclamping, when the forms are to be moved outward for the second pour, or the pour of cellular concrete.

FIG. 7C illustrates a removable box truss 303. The removable box truss system is configured to support both pitched roofing systems as shown in FIG. 3G as well as flat roofing/flooring systems. The removable box truss system works with the horizontal shoring system, plastic forming panels and fiberglass tie rod and anchor system to create a removable formwork for creating the composite concrete building component. An exemplary box truss 303 can have a length L₇ which is about 1.83 meters (6.0 feet) and a height H₇ which is about 23 centimeters (9.0 inches). The box trusses can come in multiple lengths which allow almost any length of truss to be constructed. The box truss system is designed to be used multiple times (such as 100 times or more). The box truss system supports not only pitched and flat roofing but also aids in supporting mid-span beams and posts.

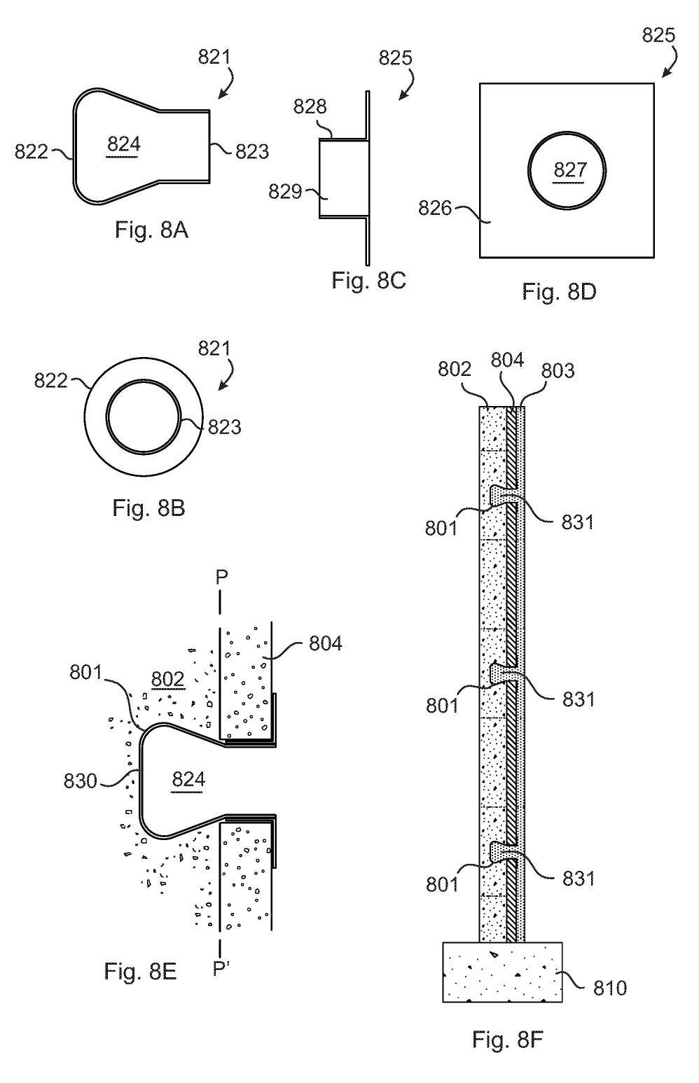

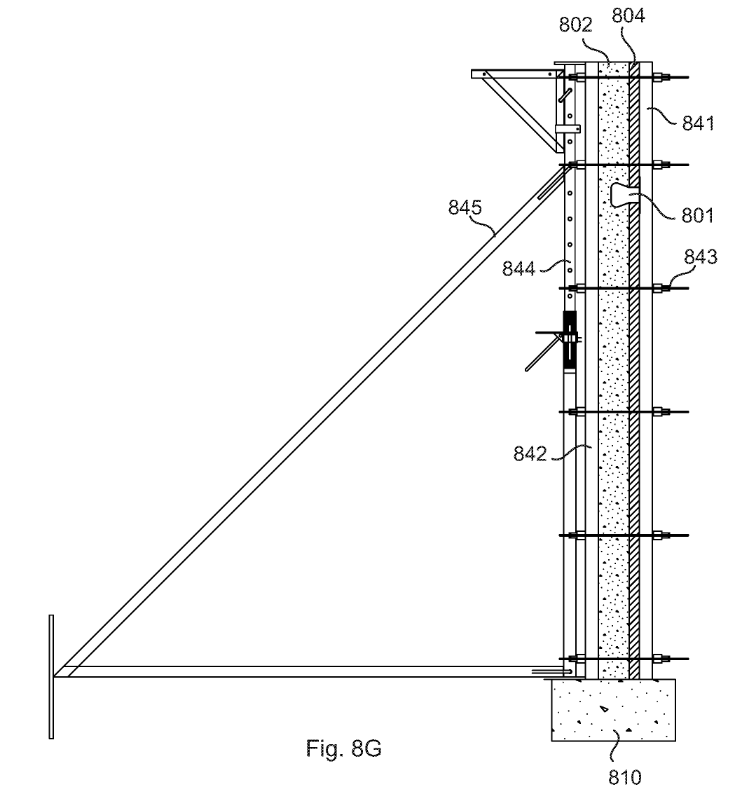

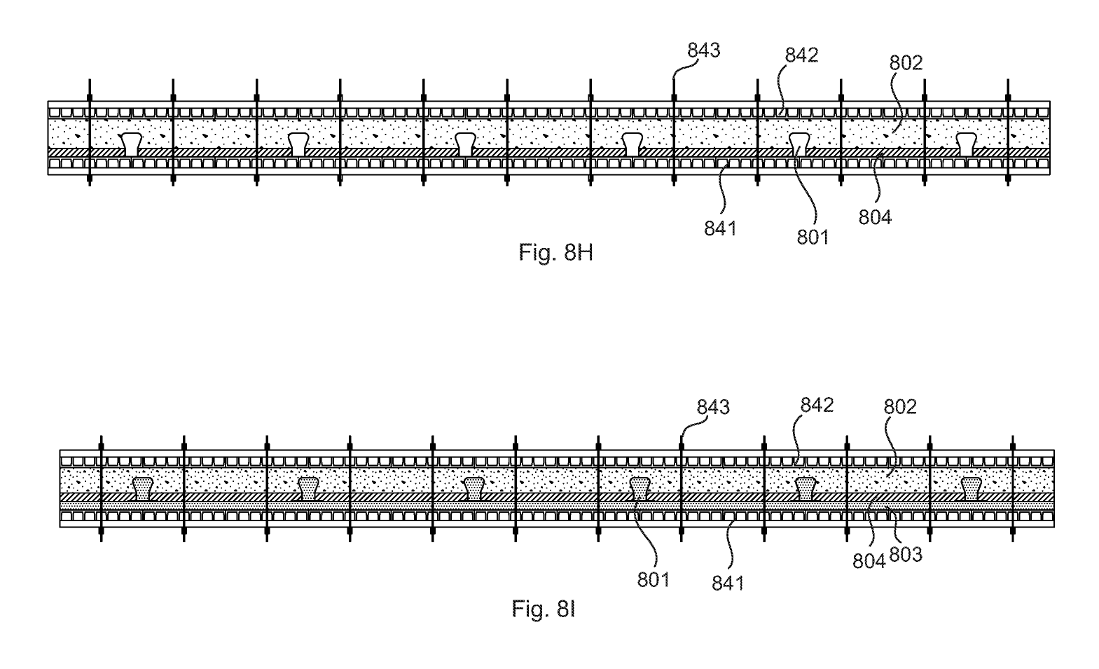

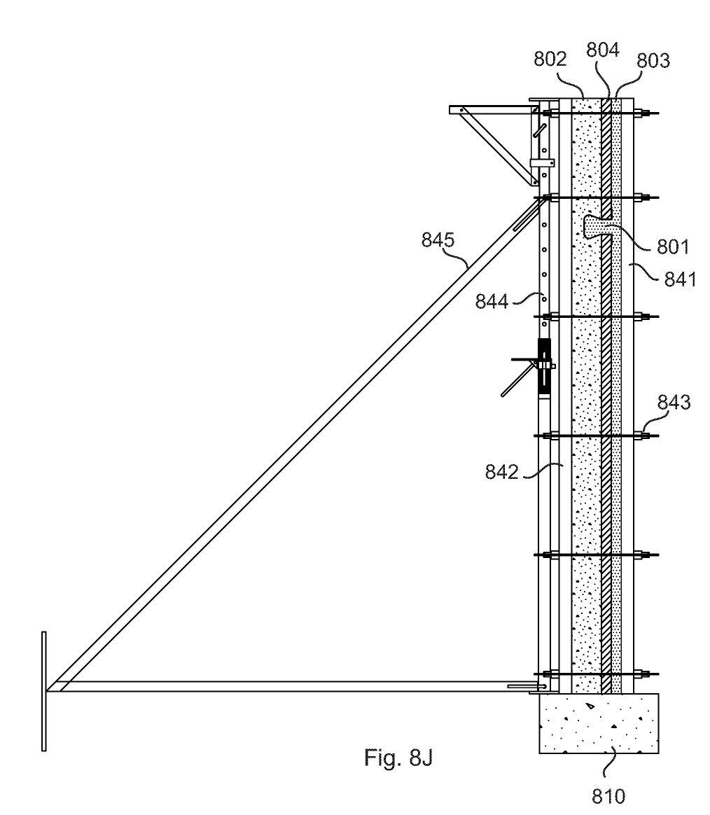

Referring now to FIGS. 8A-81 there is shown an alternate exemplary embodiment of composite concrete building component adapted to provide for an insulated basement wall system. The component uses an array of internal hollow bulb fastening structures 801 to adhere concrete layers 802,803 straddling a central rigid foam layer 804 in a stratiform manner. A structural concrete layer 802 stands stratiformly adjacent to a rigid foam layer 804 made from insulating rigid EPS or PLA closed-cell foam of the type according to previous embodiments. The structural concrete has a substantially planar surface which interfaces with the substantially planar surface of the rigid foam layer along an interface plane P-P′. A number of hollow bulb structures 801 pass through apertures in the rigid foam layer and penetrate through the interface plane to engage into the structural concrete layer.

As shown in FIGS. 8A-8D, each of the bulb fastening structures 801 includes two pieces, namely, a head piece 821 having a bulbous closed end 822 and an opposite circular open end 823 leading to an internal chamber 824, and a base piece 825 having a square-shaped base flange 826 and a central circular hole 827. A cylindrical engagement wall 828 extends from the periphery of the hole to form a hollow cylindrical tunnel 829. The two pieces are mated in axial alignment of the cylindrical engagement wall of the base piece with circular open end of the head piece.

As shown in FIG. 8E, the bulb fastening structure 801 penetrates through the rigid foam layer 804 to engage the structural concrete layer 802. The bulbous head of the bulb fastening structure forms a prominence 830 which extends into the structural concrete layer so that part of the internal chamber 824 resides beyond the interface plane P-P′.

As shown in FIG. 8F, a layer of cellular concrete 803 is stratiformly adjacent to the rigid foam layer 804 on the opposite side from the structural concrete layer 802. Portions 831 of the cellular concrete layer extend into the internal chamber 824 of each of the bulbous fastening structures 801. When the concrete hardens, the filled bulb fastener structures effectively bond the cellular concrete and structural concrete layers together while straddling the rigid foam.

Referring now to FIGS. 8G-8H, to lay out the formwork for the composite concrete building component adapted to provide for an insulated basement wall system, a chalk line can be used to mark on the footings 810 where the outside/inside edge of forms should be placed. To set the form panels, the inside of wall form panels 841 are set according to engineered plans and in conjunction with layout lines on the footings. As described above in connection with earlier embodiments, two stage window and door bucks, and reinforcement bars can be placed. Layers of rigid foam 804 are set against the interior form panels. Then, stay-in-place locking bulbs fastener structures 801 are or have been set with the rigid foam layer. Exterior form panels 842 are set. A tie rod and anchor system 843 including tie rods, tie rod anchors, and support struts can be installed securing positions of form panels. The spacing of form panels can vary from 15 cm (6″) or less to 20 cm (8″) or more depending on engineering requirements. Shoring 844 and bracing 845 can secure the form panels. The structural concrete layer 802 can then be poured. The structural concrete 802 hardens and cures to a level that it can support itself.

Referring now to FIGS. 8I-8J, the interior form panels 841 are moved inwardly away from the foam layer 804 about 5 cm (2 inches). One or more electrical conduits can be placed, and the interior forms are leveled and rebraced. Finally, cellular concrete layer 803 is placed, flowing into the bulbs 801 linking the structural concrete layer, foam layer and cellular concrete layer together.

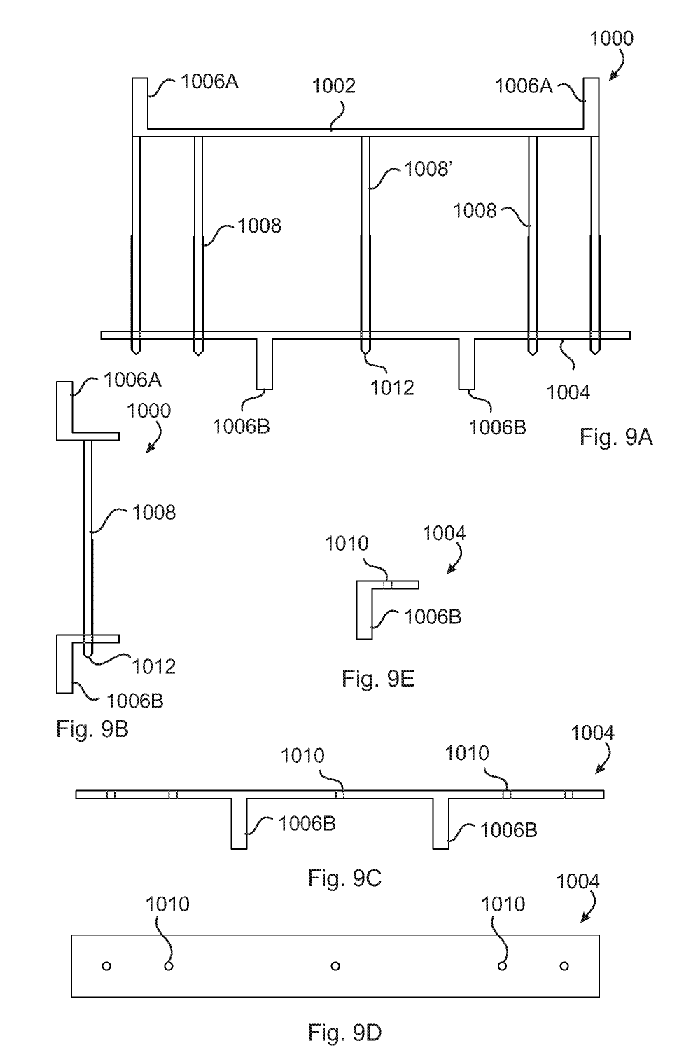

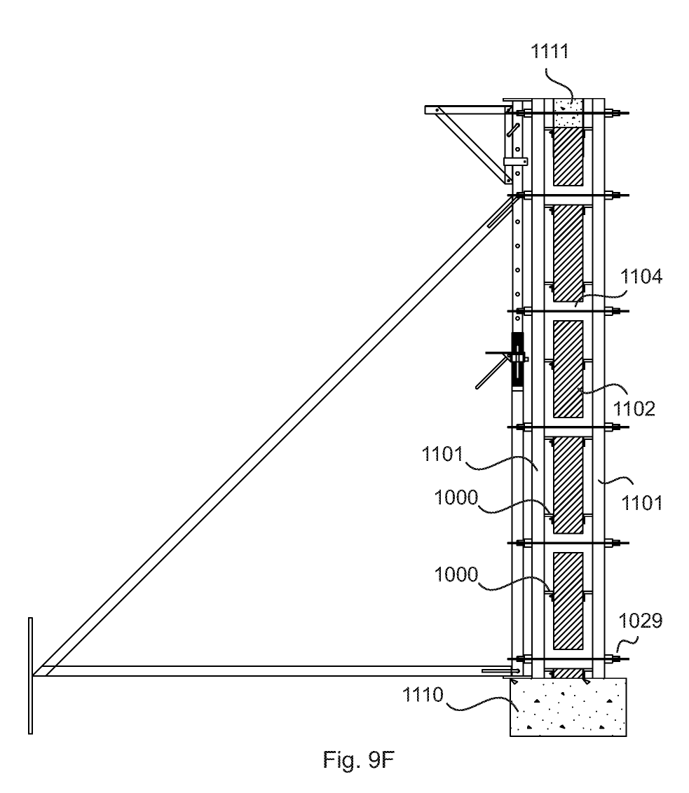

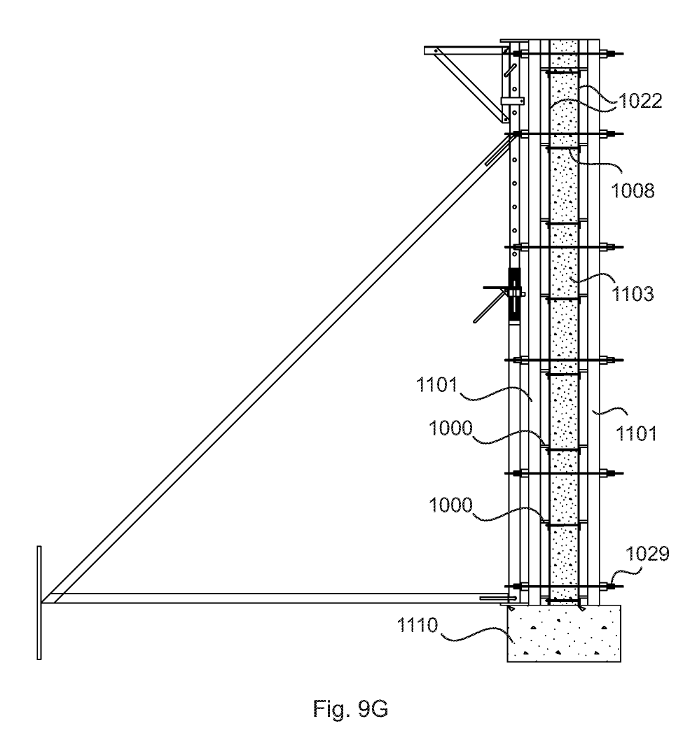

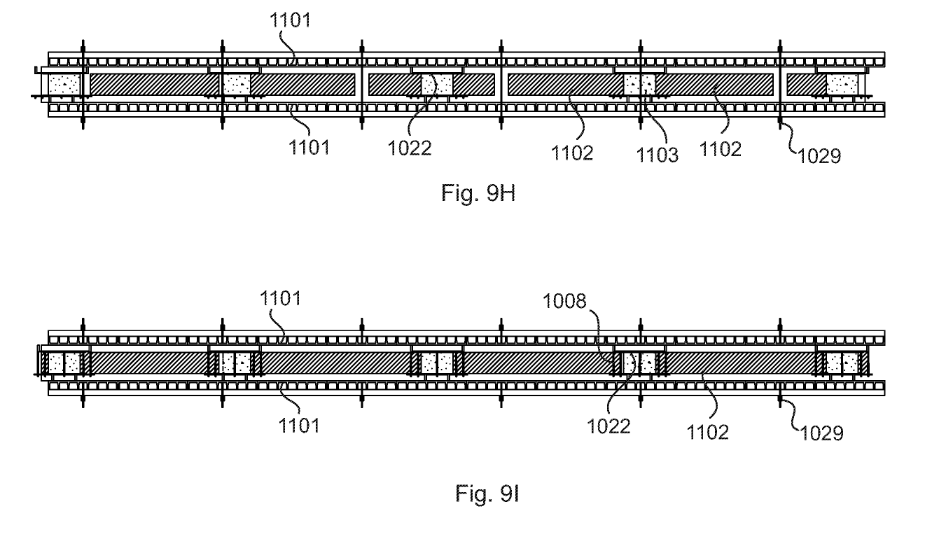

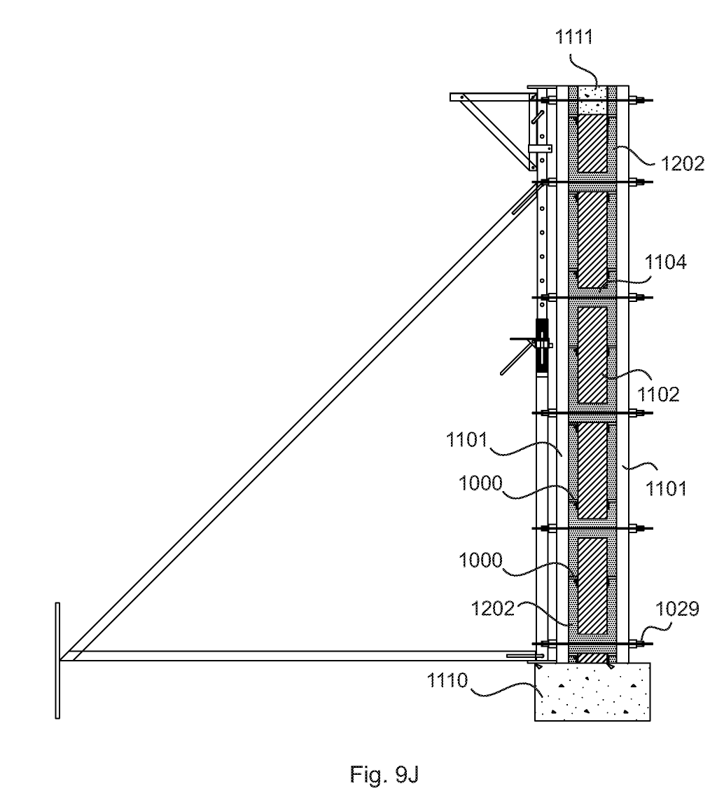

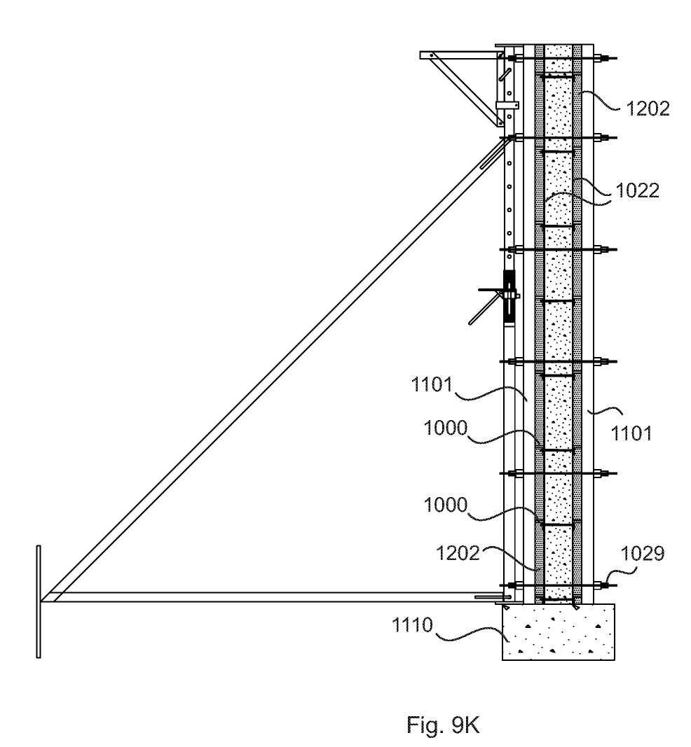

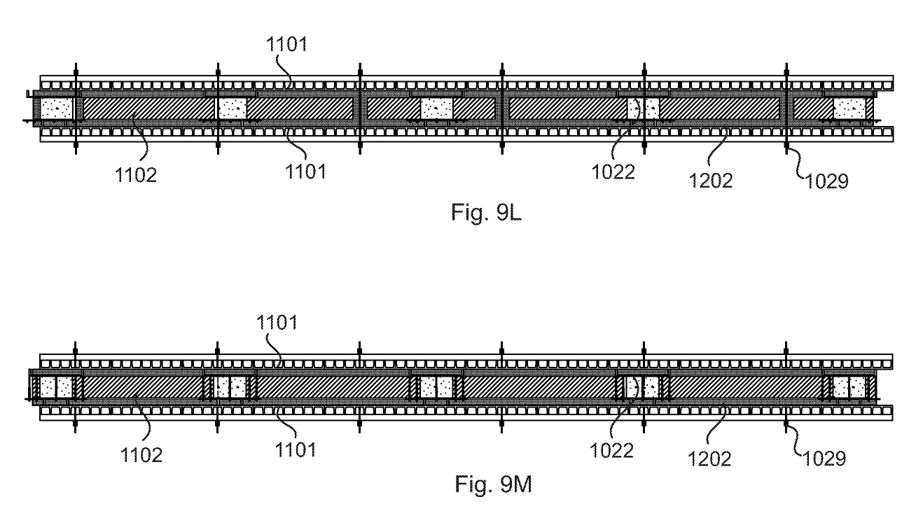

FIGS. 9A-9H illustrate a form spacer for use in constructing a composite concrete and foam building component used in an insulated concrete wall system, having one or more features consistent with the present disclosure. The form spacers provide the ability to construct a composite cellular concrete wall without having to move the form panels between pouring the reinforced concrete posts and beams and pouring the cellular concrete.

As shown in FIGS. 9A-9E, each form spacer 1000 can have two parts, a first part 1002 and a second part 1004. Each of the parts may include cellular concrete spacers 1006A, 1006B. The cellular concrete spacers 1006A of the first part 1002 of the form spacer may be offset laterally from the cellular concrete spacers 1006B of the second part 1004 of the form spacer. The first part 1002 of the form spacer may include tines 1008. The second part 1004 of the form spacer may include apertures 1010 adapted to receive at least a portion of the tines. The tines 1008 may include tapered ends 1012 to facilitate engagement of the tines with the apertures. In some implementations, the first part 1002 of the form spacer may include an optional tine 1008′. In some variations, the tines may be approximately 0.8 centimeter ( 5/16 inch) long. The form spacer may include a tine locking mechanism. The tines 1008 may engage and lock into the holes of the second part 1004 of the form spacer.

In some variations, the form spacers 1000 may be formed from plastic, metal, wood, and/or other materials. In some variations the form spacers may be formed from plastic injection.

FIGS. 9F-9I illustrate a first state of constructing an insulated concrete wall system, in which posts and beams are formed that include the form spacers 1000. Standard footings 1110 are first provided. The dimensions of the area bounded by one or more walls of the wall system, a chalk line can be used to mark on the footings where the outside/inside edge of forms should be placed. Next, the form panels 1101 are set. One side of the wall forms is set according to the engineered plans and in conjunction with layout lines on the footings. Two stage window and door bucks are placed as per plan detail. Internal foam blocks 1102 are placed using “spacers” between foam blocks to create a conduit void which will become a post 1103, i.e. a conduit into which structural concrete can be poured. Form spacers are installed at locations corresponding to the location of the posts. The form spacers may be disposed at 30 centimeter (12 inch) vertical increments along the location of the posts. The form spacers may engage with the internal foam blocks. The tines 1008 may pierce the internal foam blocks. The tines may be disposed through holes within the internal foam blocks. The form spacers having cellular concrete spacers create a cellular concrete void between the conduit void and internal foam blocks and the form panel. The conduit void can be at least partially filled with rebar or other structures to maintain structural integrity. The internal foam blocks are placed at a height equal to the bottom of the structural beams 1111. The uppermost form spacer may provide a shelf. The shelf may facilitate supporting a board on which to provide formwork for the pouring of reinforced structural concrete beams. Link cylinders 1104 are placed as required. Expanded metal lath 1022 may be installed between the form spacers. The other side of the form panels are set using a tie and anchor system 1029 compressing the internal foam blocks. A strut may be positioned on the outermost edge of the form panels as part of the anchoring system. Structural concrete is then placed in or poured into the conduit voids created by the “spacers” between internal foam blocks, creating substantially vertical posts, and on top of the internal foam blocks, creating substantially horizontal beams.

The form spacers 1000 may provide a conduit void diameter of between 5 centimeters (2 inches) and 30 centimeters (12 inches). The form spacers may provide a conduit void diameter of between 10 centimeters (4 inches) and 20 centimeters (8 inches). The form spacers may provide a conduit void diameter of approximately 20 centimeters (8 inches). The form spacers having cellular concrete spacers may provide cellular concrete voids between base panels of the form spacers and the form panels. The cellular concrete spacers may provide cellular concrete voids of between 5 centimeters (2 inches) and 30 centimeters (12 inches). The cellular concrete spacers may provide cellular concrete voids of between 10 centimeters (4 inches) and 20 centimeters (8 inches). The cellular concrete spacers may provide cellular concrete voids of approximately 20 centimeters (8 inches).

In some variations a diamond lath may be installed on the foam blocks. In other variations, a board, such as a wooden board or a vinyl board, may be slotted into the form spacer to provide structure onto which the cellular concrete may bond. The form spacers and/or foam blocks may include a diamond lath pattern to facilitate adherence by the cellular concrete.

FIGS. 9J-9M illustrate a second stage of constructing an insulated concrete wall system having form spacers 1000. The form panels 1101 may be already positioned, due to the presence of the form spacers at a desired position away from the edge of the internal foam blocks 1102. Cellular concrete 1202 may be poured into the cellular concrete void between the form panels and the internal foam blocks/structural concrete posts/beams. In some exemplary embodiments, cellular concrete should flow at a consistency of pancake batter, allowing it to flow through internal foam blocks filling both interior and exterior cellular concrete layers and linking both layers together through the link cylinders 1104. The cellular concrete may adhere to the foam blocks, form spacers, and/or reinforced concrete beams 1111. The cellular concrete may adhere to the foam blocks, form spacers, and/or reinforced concrete beams with, or without, the use of diamond lath and/or boards provided on/adjacent the foam blocks, form spacers, and/or reinforced concrete beams.

Next, the form panels 1101 are removed, leaving the foam/structural concrete core encased on either side by hardened, cured cellular concrete. The interior and exterior wall surfaces can be touched up using a masonry block as a sanding block to remove any ridges created by joints of interior and exterior form panels, and are then ready for any of a number of finishing processes.

While the presently disclosed form spacers 1000 have been disclosed as being used in walls, one of ordinary skill in the art will understand and appreciate that the form spacers having one or more features consistent with this disclosure may be used for any of the structures herein described.

In this way one or more of the above embodiments provide a new and improved concrete forming system and structure that is environmentally friendly with a high thermal barrier and insulating properties while being insect, disaster and fire resistant. This method creates the ability to laminate together multiple densities of concrete. By sourcing multiple densities of concrete it combines the benefits of high density concrete and low density concrete together. High density concrete or structural concrete has a high compressive strength, great longevity, and is essentially impervious to weather and has reasonably good thermal properties. Low density concrete or lightweight cellular concrete has extremely high thermal and insulation properties, a low water absorption rate and low expansion and contraction rate which helps avoiding cracking.

The structural concrete framework and rigid foam can be entirely encased with light weight cellular concrete. Encasing the internal foam blocks of the wall with lightweight cellular concrete makes it essentially air tight thereby not allowing moisture, mold or other pathogens to adhere and de-laminate the wall. Because of foamed air bubbles embed throughout the cellular concrete there is little shrinking or cracking which enables thin sheets of concrete to be poured and laminated onto metal lath and rigid foam.

Another advantage of this forming system is an essentially permanent low maintenance structure with very high insulation values, making it economical to maintain temperatures in nearly any environment. The insulation value of the rigid foam blocks and lightweight cellular concrete that are used to create the wall of standard dimensions is about an R-39 which is more than twice the insulation value of a traditional stick built structure which can typically provide about R-19. Traditional built structures made from lumber need continual upkeep and maintenance. They remain vulnerable to the elements and will decompose over time. When met with undesired events such as rain, fire, wind and heavy moisture, a traditional stick built structure is prone to failure and may need repair and further maintenance. Concrete structures can often withstand nature's elements for hundreds of years remaining intact with little effect by the various and extreme forces surrounding it. The above described structural post and beam system satisfy and even surpass all seismic and fire ratings, while meeting California's title 24 standards for an ecological net zero structure.

Another important feature of the above described composite concrete and foam building component is that it can be readily employed in a roof forming system whereby a pitched roof can be formed with structural concrete rafters and ridged foam for insulation. This system is essentially interchangeable with the wall system and uses all of the same materials. Because the plastic form panels are watertight, the rafters can be formed in place with structural concrete against insulating rigid foam blocks to bare all the load requirements, then with spacers and metal lath create a cavity that is then filled with lightweight cellular concrete pumped in at the top of the roof ridge. A rain gutter can also be formed into the concrete at the time of this application. All the parts that link together in the wall and roof system are interchangeable and establish a structure that is both very fire resistant and highly insulated against the elements.

Before the present invention, the cost of a concrete home has been essentially unaffordable to middle-income persons in the US. This invention eliminates several subcontractors and materials bringing construction cost significantly lower. Although prior concrete forming systems have used structural concrete with re-bar and ridged foam, there has not been an economical highly insulated, concrete building design that includes laminating multiple densities of concrete with ridged foam and structural expanded metal lath.

The invention produces a hermetically sealed building where the concrete has been poured in place and, upon removal of the plastic forms, where the inside and outside walls are finished except for the final plaster coat on the inside wall and color coat on the outside wall. This illuminates the need for carpentry, stucco, insulation and drywall. The interchangeable parts used for forming the roof allows for multiple systems to be linked together to produce a superior building.

While the exemplary embodiments of the invention have been described, modifications can be made and other embodiments may be devised without departing from the spirit of the invention and the scope of the appended claims.

1. A composite building component comprises:
a pair of stratiform layers of cellular concrete straddling a core;
wherein said core comprises a framework of structural concrete interspersed with a number of rigid, closed-cell foam blocks.

2. The component of claim 1, wherein said component further comprises:
a footing;
said framework comprises:
a beam elongated along a width dimension;
an adjacent pair of posts elongated along a length dimension and separated in said width dimension by a first one of said foam blocks; and,
wherein each of said posts has a first end contacting said beam and a second end contacting said footing.

3. The component of claim 2, wherein said block is hermetically encased by said framework, said footing and said layers.

4. The component of claim 3, which further comprises:
said framework having a front surface and a back surface;
said first one of said foam blocks having a front face and a back face;
wherein said front surface and said front face are coplanar; and,
wherein said front surface and said front face are coplanar.

5. The component of claim 4, wherein said first one of said foam blocks is shaped and dimensioned to have at least one passageway extending therethrough from said front face to said back face.

6. The component of claim 5, wherein said at least one passageway is substantially filled with a plug of cellular concrete contiguously connecting said pair of layers.

7. The component of claim 6, wherein said at least one passageway has a substantially cylindrical shape.

8. The component of claim 7, wherein said at least one passageway has a cross-sectional diameter of between about 2.5 centimeters and 15 centimeters.

9. The component of claim 4, wherein said core further comprises:
a lathwork extending over a portion of said front surface.

10. The component of claim 1, wherein said framework is a unitary, contiguously poured amount of structural concrete.

11. The component of claim 1, wherein said framework comprises bars of reinforcement.

12. The component of claim 1, wherein said plurality of foam blocks comprise material selected from the group consisting of expanded polystyrene (EPS) foam, and expanded poly-lactid acid (PLA) foam.

13. The component of claim 12, wherein said rigid, closed-cell-type foam has a density of between density of between about 22 kilograms per cubic meter (1.4 pounds per cubic foot) and 48 kilograms per cubic meter (3.0 pounds per cubic foot).

14. The component of claim 12, wherein each of said blocks has a surface compressive strength of at least 0.1 megapascal (15 pounds per square inch).

15. The component of claim 1, which further comprises:
said structural concrete having an average density of about 2400 kilograms per cubic meter; and
said cellular concrete having an average density of between about 400 and 1600 kilograms per cubic meter.

16. The component of claim 1, which has been formed into a section of a structure wall or a section of a structure roof.

17. The combination of a pair of stratiform layers of cellular concrete straddling a core;
wherein said core comprises a framework of structural concrete interspersed with a number of rigid, closed-cell foam blocks.

18. A composite foam and concrete building component comprises:
a structural concrete layer;
a rigid foam layer stratiformly adjacent to said structural concrete layer;
a plurality of spaced apart, hollow bulb fasteners, each having an internal chamber;
wherein each of said hollow bulb fasteners penetrates through said foam layer and includes a prominence extending into said structural concrete layer;
a cellular concrete layer stratiformly adjacent to said rigid foam layer; and,
wherein portions of said cellular concrete layer extend into said internal chamber of each of said hollow bulb fasteners.

19. The component of claim 18, wherein said structural concrete layer and said rigid foam layer meet at a substantially planar interface surface; and wherein said internal chamber of each of said hollow bulb fasteners extends through a plane coplanar with said planar interface surface.

20. A process for forming a composite concrete and foam building component comprises:
placing laterally spaced apart blocks of rigid, closed-cell foam between concrete form panels atop a footing;
extending a lathwork between said blocks of rigid, closed cell foam to form columnar voids between said blocks of rigid, closed-cell foam;
leaving a pair of gaps between said form panels and straddling said foam blocks;
first pouring structural concrete into said voids to form posts within said voids and to form a beam capping said posts;
second pouring of cellular concrete into said gaps to form layers contacting said posts and said blocks; and,
allowing said pourings to cure.

21. The process of claim 20, wherein said first and second pouring occur in absence of a movement of said form panels.

22. The process of claim 20, which further comprises placing of spacers between said blocks and said form panels to form said gaps.

23. A composite concrete building component comprising:
one or more reinforced concrete posts extending laterally across a substantial portion of the width of the composite concrete building component;
one or more internal foam blocks disposed between the one or more reinforced concrete posts;
a first cellular concrete layer extending across a substantial portion of the width and length of a first side of the composite concrete building component external to a first side of the one or more reinforced concrete posts and the one or more internal foam blocks; and,
a second cellular concrete layer extending across a substantial portion of the width and length of the composite concrete building component external to a second side of the one or more reinforced concrete posts and the one or more internal foam blocks.

24. The composite concrete building component of claim 23, further comprising:
one or more form spacers disposed at positions corresponding to locations of the reinforced concrete posts, the one or more form spacers comprising one or more cellular concrete spacers disposed within the first cellular concrete layer and the second cellular concrete layer.

25. The composite concrete building component of claim 23, further comprising:
a first stage of a two-stage window and/or door buck substantially disposed within the internal foam blocks; and,
a second stage of the two-stage window and/or door buck substantially disposed within the cellular concrete layers.

26. The composite concrete building component of claim 23, wherein the concrete posts and beams and internal foam blocks have been leveled and plumbed.

27. The composite concrete building component of claim 23, wherein the composite concrete construction component is a substantially vertical wall.

28. The composite concrete building component of claim 23, wherein the composite concrete construction component is configured as a roof.

29. The composite concrete building component of claim 28, further comprising:
one or more channels configured to function as rain gutters disposed adjacent a first edge of the composite concrete building component and extending substantially along the length of the composite concrete building component.

30. The composite concrete building component of claim 23 further comprising:
one or more electrical conduits substantially disposed in the cellular concrete layers;
one or more locking bulbs disposed into the internal foam blocks, the one or more locking bulbs filled with cellular concrete.

31. A method of constructing a composite concrete building component comprising:
setting a first set of one or more form panels to provide a supportive structure for a first side of a composite concrete building component when constructing the composite concrete building component, the one or more form panels extending substantially along the width and length of the composite concrete building component;
installing one or more internal foam blocks comprising spaces between individual ones of the internal foam blocks to create substantially vertical voids extending along a substantial portion of the width of the composite concrete building component;
setting a second set of one or more form panels to provide a supportive structure for a second side of a composite concrete building component when constructing the composite concrete building component;
securing the second set of one or more form panels to the internal foam blocks using a tie and anchor system, the tie and anchor system configured to cause the first and second sets of one or more form panels to compress the internal foam blocks; and,
pouring reinforced structural concrete into the voids to create concrete posts and on top of the internal foam blocks to create one or more substantially horizontal beams.

32. The method of claim 31, further comprising:
repositioning the first and second sets of form panels away from the internal foam blocks and reinforced concrete posts to form voids between the internal foam blocks and reinforced concrete posts and the first and second sets of form panels, the repositioning performed after the reinforced structural concrete has sufficiently cured to become self-supporting; and,
pouring cellular concrete into the voids between the first and second sets of form panels and the internal foam blocks and reinforced concrete posts.

33. The method of claim 32, further comprising:
removing the first and second sets of form panels after the cellular concrete has cured sufficiently to be self-supporting.

34. The method of claim 31, further comprising:
installing one or more form spacers concurrently with installing the one or more internal foam blocks, the one or more form spacers disposed at positions corresponding to locations of the reinforced concrete posts, the one or more form spacers comprising one or more cellular concrete spacers configured to provide a void between the form spacers and the internal foam blocks; and,
pouring cellular concrete into the voids between the form spacers and the internal foam blocks.

35. The method of claim 32, further comprising:
installing, prior to installing the one or more internal foam blocks, a first stage of a two-stage window and/or door buck; and,
installing, prior to pouring the cellular concrete, a second stage of the two-stage window and/or door buck.

36. The method of claim 31, further comprising:
installing link cylinders through the one or more internal foam blocks, the link cylinders configured to receive ties for a tie and anchor system.

37. The method of claim 32, further comprising:
levelling and plumbing the reinforced concrete posts, beams and internal foam blocks prior to pouring the cellular concrete.

38. The method of claim 31, wherein the composite concrete construction component is a substantially vertical wall.

39. The method of claim 31, wherein the composite concrete construction component is configured as a roof component and the method further comprises:
providing a plurality of shoring posts and/or trusses, individual ones of the shoring posts and/or trusses having predetermined heights and disposed at predetermined locations to support a roof component.

40. The method of claim 39, further comprising:
installing rain gutter forms prior to pouring the cellular concrete.

51. The method of claim 41, wherein repositioning the first and second sets of form panels away from the internal foam blocks and reinforced concrete posts includes moving the first and second sets of form panels away from the internal foam blocks and reinforced concrete posts.

52. The method of claim 42, wherein the composite concrete building component is a basement wall and the method further comprises:
installing one or more electrical conduits prior to pouring of the cellular concrete;
installing locking bulbs into the internal foam blocks; and, wherein the cellular concrete is poured into the void between the form panels and the internal foam blocks and into the locking bulbs.
